(19) United States
(12) Patent Application Publication
(10) Pub. No.: US 2026/0222195 A1
(43) Pub. Date: Jul. 30, 2026

(54) VERIFIABLE ENTERPRISE MESSAGING PROTOCOL (VEMP) FOR PRE-DECRYPTION ADMISSION CONTROL OF ENCRYPTED COMMUNICATIONS USING ARTIFACT-BOUND STATE MACHINES

(71) Applicant: Papa Gora Samb, Ellenwood, GA (US)

(72) Inventor: Papa Gora Samb, Ellenwood, GA (US)

(73) Assignee: Yandeh Holdings inc, Wilmington, DE (US)

(21) Appl. No.: 19/574,464

(22) Filed: Mar. 23, 2026

(51) Int. Cl. H04L 9/08; G06F 21/86

(52) U.S. Cl. CPC H04L 9/0891; G06F 21/86; H04L 9/0816; H04L 9/0877

(57) ABSTRACT

A communication governance system enforces state-machine-governed, artifact-bound, multi-plane access control over encrypted communication objects. A structured governance artifact cryptographically bound to each communication object stores state-transition precondition records evaluated before any decryption key is released, sealed within a tamper-resistant hardware boundary. Delivery does not enable content access; access requires affirmative state machine advancement through artifact-validated admission and release gates in a second communication plane. Post-release revocation is enforced through hardware-boundary key invalidation within a bounded enforcement latency independent of recipient endpoint cooperation. A lineage tracking module enforces authority constraints on derived communications including AI-agent-generated communications, through a lineage continuity record with configurable maximum-authority ceilings. A verifiable receipt generator produces tamper-evident cryptographically signed receipts for every governance event, appended to a hash-chained audit log. Decryption key release is conditioned on affirmative state machine advancement, providing governance independent of transport-layer security, gateway filtering, and information rights management.

### CROSS-REFERENCE TO RELATED APPLICATIONS

This application is an original nonprovisional utility patent application filed under 35 U.S.C. § 111(a).

### STATEMENT REGARDING FEDERALLY SPONSORED RESEARCH OR DEVELOPMENT

Not applicable.

### INCORPORATION BY REFERENCE

Not applicable.

### STATEMENT REGARDING PRIOR DISCLOSURES BY THE INVENTOR OR A JOINT INVENTOR

Not applicable. The subject matter of the present disclosure has not been publicly disclosed prior to the filing of this application.

### BACKGROUND OF THE INVENTION

### Field of the Invention

The present disclosure relates to secure electronic communications and, more particularly, to systems, methods, protocols, and machine-readable artifacts for multi-plane communication control, state-machine-governed admission and release, artifact-bound cryptographic authorization, lineage-enforced constraint propagation, tamper-evident state transition verification, and dynamic post-release access governance in distributed messaging architectures. Abbreviations used in this specification are defined in paragraph [0082A].

### Description of the Related Art

Conventional communication systems, including secure messaging systems, encrypted email systems, and digital rights management platforms, are architecturally deficient in six independently identifiable technical respects. The present disclosure is specifically directed to remedying each of these deficiencies through a novel combination of technical mechanisms not present in, or rendered obvious by, any individual prior art system or straightforward combination thereof.

First, conventional systems lack pre-access admission control enforced by a state machine. In existing architectures, including those implementing S/MIME, OpenPGP, and TLS-based secure transport, no formally defined admission state exists between message delivery and content access, and no state-transition validation logic is enforced against state-transition preconditions stored in association with a structured message authority artifact. The principal trust event is possession of a decryption key or algorithmic verification of a sender signature, neither of which constitutes an artifact-gated, state-machine-governed admission evaluation.

Second, conventional systems exhibit tight architectural coupling between message delivery and content access. Message delivery to a recipient endpoint presumptively enables access attempts by any party possessing a decryption credential, without independent evaluation of artifact-encoded admission preconditions or enforcement of the behavioral consequences of failed admission, including mandatory quarantine of the communication object in the first communication plane without any exposure of the encrypted content to recipient systems or processes.

Third, conventional systems lack a formally defined, multi-state communication state machine with artifact-bound state-transition validation. Architectures implementing S/MIME, OpenPGP, information rights management platforms, and secure retrieval portals do not maintain discrete protocol states corresponding to delivered, admission-pending, admitted, release-qualified, released, partially-released, reevaluation-pending, revoked, and expired conditions, and do not enforce that each state transition requires validation of state-transition preconditions stored in association with a governing artifact.

Fourth, conventional systems lack cryptographically enforced lineage constraint propagation. Derived communications, including replies, forwards, delegations, machine-generated responses, and AI-agent-originated communications, are not cryptographically bound to the authorization constraints of the parent communication object, and no technical mechanism prevents a derived communication from asserting a wider authority scope or a weaker cryptographic profile.

Fifth, conventional systems employ static, point-in-time authorization models and provide no integrated protocol-level mechanism enabling post-release revocation of decryption keys, downgrade of rendering permissions, or state machine rollback in response to post-release events.

Sixth, conventional systems do not generate tamper-evident, cryptographically signed records of state transitions, admission events, release events, or post-release control operations, and therefore cannot provide verifiable audit evidence of the governance conditions under which access to encrypted content was granted, modified, or revoked. Existing supply chain transparency architectures such as the IETF Supply Chain Integrity, Transparency, and Trust (SCITT) architecture issue receipts for artifact registration statements signed by the submitting issuer; such receipts are not generated by a third-party enforcement component independent of both sender and recipient, are not typed to communication governance event categories, are not bound to a communication state machine record, and are not required to employ post-quantum signing algorithms. No existing standard communication protocol, audit log system, or receipt-issuance framework generates HSM-signed, governance-event-typed, state-machine-bound, post-quantum-signed receipts as a mandatory protocol function covering all five governance event categories required for non-repudiable regulatory compliance evidence.

### Prior Art Considered

The following prior art categories were considered in preparing this application. The technical distinctions between the present disclosure and each category are set forth in the Detailed Description and are incorporated herein by reference for prosecution history purposes. Each category is analyzed below with respect to the six independently identifiable technical deficiencies identified in this Background.

### A. Encrypted Email and Signature Protocols

U.S. and international standards and systems implementing S/MIME (RFC 8551) and OpenPGP (RFC 4880) were considered. Such systems provide content encryption and digital signature verification for electronic communications. However, the present disclosure is architecturally distinct from, and not rendered obvious by, S/MIME or OpenPGP in the following technically significant respects.

First, S/MIME and OpenPGP are not secure communication governance architectures. Encryption and signing are incidental to the present disclosure; the present disclosure's core mechanism operates before any decryption occurs, enforcing whether a communication is ever admitted into the controlled communication plane at all. S/MIME has no concept of an admission state. It has no formally defined communication state machine. It has no post-delivery revocation mechanism that operates independently of the recipient endpoint. Characterizing the present disclosure as an encrypted email system would materially misrepresent its scope and undersell the architectural distinction.

Second, S/MIME and OpenPGP treat algorithmic signature verification or decryption-key possession as the principal and substantially sole trust event. No formally defined admission state exists between message delivery and content access. No state-transition validation logic is enforced against state-transition preconditions stored in association with a structured message authority artifact. The principal trust event in those systems—possession of a decryption key or verification of a sender signature—does not constitute an artifact-gated, state-machine-governed admission evaluation.

Third, S/MIME and OpenPGP do not implement a communication state machine, artifact-stored state-transition precondition validation, defined failure enforcement behavior, verifiable receipt generation, lineage-bound constraint propagation, or post-release state machine rollback with bounded revocation enforcement latency. The present disclosure introduces all six of these mechanisms as an inseparable coordinated system. Each mechanism individually appears in no prior art reference, and the combination of all six is novel.

### B. Transport-Layer Security Systems

Systems implementing transport-layer security for electronic messaging, including TLS-based SMTP relay encryption, gateway-to-gateway encrypted tunnels, and STARTTLS configurations, were considered. Such systems protect the communication channel between nodes but have no involvement in, or control over, what happens to a communication object after it is delivered.

Transport-layer security systems are not communication governance architectures. They govern the pipe, not the message. Once a communication object has been delivered, TLS has no further involvement. TLS has no concept of the communication object as a governed entity, no state machine governing the communication object's lifecycle, no admission control engine, no artifact evaluation, no post-delivery revocation, and no verifiable receipt generation. The present disclosure operates above the transport layer entirely; the outer communication plane may use TLS for channel security, but the present disclosure's mechanisms are independent of and orthogonal to transport-layer security. The six deficiencies identified in the Background are not addressed by TLS or any transport-layer mechanism.

### C. Secure Email Gateway Filtering Systems

Secure email gateway filtering systems, including anti-spam, anti-malware, domain-authentication, and data-loss-prevention filtering products from vendors including Proofpoint, Mimecast, and Abnormal Security, applied at a mail transfer boundary, were considered. Such systems sit at the mail transfer boundary and filter inbound messages before delivery. They operate on the outer envelope using heuristics, threat signatures, and sender reputation scoring, making a binary deliver-or-block decision at the boundary.

The present disclosure is not a filter and is not rendered obvious by secure email gateway architectures. A gateway decides whether a message arrives; the present disclosure decides whether a delivered message is ever admitted into a controlled communication plane. These are architecturally distinct operations. Gateway filtering occurs before delivery; the present disclosure's admission evaluation occurs after delivery, in the second communication plane, without decrypting the encrypted content. Gateway systems do not implement a communication admission matrix, message authority artifact-governed state machines, recipient-side release qualification, post-delivery dynamic access modification, HSM-bound key management, verifiable receipts, or lineage-bound constraint propagation. The present disclosure addresses the threat class that gateway systems cannot address: a communication from a legitimate-appearing or legitimately-authenticated sender domain that has been compromised, or whose content should not be admitted regardless of routing validity.

### D. Information Rights Management and Data Loss Prevention Platforms

Enterprise information rights management and data-loss-prevention platforms, including Microsoft Purview Information Protection, Forcepoint, and similar policy-enforcement systems applying sensitivity labels or rights-managed document wrappers, were considered. Such systems apply content controls to communications or documents after they have been accepted into the recipient environment. A communication that has been received and processed by an IRM system is already inside the recipient's perimeter; IRM then restricts what can be done with the content.

The present disclosure is architecturally distinct from IRM and DLP platforms in a technically dispositive respect: the present disclosure's admission evaluation occurs before any content exposure to the recipient environment, not after acceptance. The separation between the present disclosure and IRM systems is architectural, not merely temporal. An IRM system has no mechanism to prevent a delivered, decrypted communication from being accessed; it can only restrict post-access operations such as printing, copying, or forwarding. The present disclosure prevents any content from being decrypted or accessed until the state machine's artifact-evaluated admission and release preconditions are satisfied. Furthermore, IRM systems do not implement a communication state machine with artifact-bound state-transition validation, do not provide pre-access admission control enforced before decryption, do not provide HSM-governed decryption-key release conditioned on state machine advancement, and do not provide post-release key revocation with bounded enforcement latency independent of endpoint cooperation. In particular, portal-based encrypted message products such as Microsoft Purview Advanced Message Encryption implement revocation by denying portal authentication, which prevents access through the portal interface but does not invalidate decryption keys within a hardware boundary; such revocation fails when a recipient has downloaded or cached content, when the recipient's environment cannot reach the portal, or when the portal is unavailable. The present disclosure's revocation is implemented as HSM-boundary key invalidation, which renders the encrypted content inaccessible on all recipient systems within a bounded enforcement latency regardless of endpoint behavior, portal availability, or prior content distribution.

### E. Secure Message Retrieval Portal Architectures

Secure message retrieval portal architectures, in which an outer notification email contains a retrieval link directing the recipient to an externally hosted content gateway, were considered. Such architectures condition content retrieval on recipient authentication at retrieval time. The outer envelope and inner content separation in such architectures superficially resembles the dual-plane architecture of the present disclosure.

However, secure retrieval portals do not implement a message authority artifact required for state machine advancement, formal communication-state separation as a protocol primitive, cryptographic profile compliance as a state-machine-gated prerequisite, lineage-bound constraint propagation, or post-release state machine rollback. A retrieval portal's access control is an HTTP authentication gate at a web endpoint; it is not a formally defined communication state machine with artifact-bound state-transition precondition records. Once authenticated, a portal simply displays the message. There is no admission control engine evaluating recipient device posture, identity assurance level, or cryptographic profile. There is no post-delivery revocation mechanism; content served once by a portal remains in the recipient's browser cache and cannot be recalled. There are no verifiable receipts of state transitions.

### F. Zero-Trust Network Access Systems

Zero-trust network access systems and identity-aware proxy architectures, including implementations of the principles set forth in NIST SP 800-207, were considered. Such systems govern resource access based on user or device identity, applying the principle that no user or device should be trusted by default regardless of network location. Zero-trust access products govern which users on which devices can reach which network resources.

The present disclosure is not a zero-trust network access system and is not rendered obvious by ZTA architectures. The subject of ZTA is resource access-whether a user or device may connect to a network resource. The subject of the present disclosure is communication object governance-whether a specific communication object, from a specific sender authority, carrying a specific message class, under a specific cryptographic profile, may be admitted to a controlled communication plane and released to a recipient. These are architecturally different subjects governed by different mechanisms. The policy in a ZTA system is held by the policy engine. In the present disclosure, governance is bound to the communication object itself through the message authority artifact, which travels with the communication object and is evaluated against it at every state transition. ZTA systems do not implement communication-level state machines, verifiable receipt generation for communication governance events, lineage-bound constraint propagation across derived communications, or post-release decryption-key revocation with bounded enforcement latency. The relationship between ZTA and the present disclosure is complementary: ZTA governs access to the second communication plane infrastructure; the present disclosure governs whether a specific communication object may be admitted and released within it.

### G. Hierarchical Governance Frameworks for Encrypted Messaging

Namevari et al., “Private Hierarchical Governance for Encrypted Messaging,” Proceedings of the 2024 IEEE Symposium on Security and Privacy (IEEE S&P 2024), pp. 2610-2629 (arXiv:2406.19433), was considered. That work proposes layering governance logic on top of an end-to-end encrypted messaging protocol using the Message Layer Security (MLS) protocol, implementing hierarchical authority roles including community members, moderators, and platform operators, with the goal of enabling content moderation and community governance while maintaining cryptographic privacy of unreported content.

The present disclosure is architecturally distinct from, and not rendered obvious by, Namavari et al. in the following technically dispositive respects. First, that work addresses post-delivery content moderation—governance applied to content after it has been delivered and decrypted within a recipient environment. The present disclosure enforces admission control before any decryption occurs and before any content is exposed to any recipient system or process. Second, that work does not implement a formally defined communication state machine with artifact-stored state-transition precondition records; governance logic is layered on top of an existing E2EE protocol without modifying the key-release architecture. Third, that work does not employ a hardware-security-module-bound key management service conditioning decryption key release on state machine advancement. Fourth, that work does not provide post-release retroactive key revocation with bounded enforcement latency independent of endpoint behavior. Fifth, that work does not generate tamper-evident, cryptographically signed governance event receipts as a mandatory protocol function. The governance authority enforcement in that work is a community-level policy layer; the present disclosure is a communication object governance architecture enforcing admission before decryption at the protocol level.

### H. Policy Compliant Secure Messaging

Alwen et al., “Policy Compliant Secure Messaging,” Advances in Cryptology-ASIACRYPT 2025, Lecture Notes in Computer Science vol. 16246 (Cryptology ePrint Archive, Paper 2025/2179), was considered. That work introduces Policy Compliant Secure Messaging (PCSM) as a framework for end-to-end encrypted messaging systems that guarantees E2EE privacy for policy-compliant messages while detecting and reporting harmful content prior to delivery. PCSM defines roles including policy creator, auditor, and judge, and presents constructions for arbitrary policy classes including hash-based content-moderation policies encapsulating client-side scanning techniques.

The present disclosure is architecturally distinct from, and not rendered obvious by, Alwen et al. in the following technically dispositive respects. First, PCSM is a content policy predicate system whose governing question is whether message content is harmful; the present disclosure governs whether a communication object from a specific sender authority, under a specific cryptographic profile, may be admitted to a controlled communication plane and released to a recipient. Second, PCSM does not implement a hardware-security-module-bound key management service conditioning decryption key release on state machine advancement.

Third, PCSM does not implement a formal multi-state communication state machine with artifact-stored state-transition precondition records. Fourth, PCSM does not provide post-release retroactive key revocation with bounded enforcement latency independent of endpoint behavior. Fifth, PCSM does not enforce cryptographic profile compliance as a state-machine-gated admission prerequisite evaluated independently of algorithmic signature validity. Sixth, PCSM does not enforce lineage-bound authority constraints on AI-agent-generated derived communications via a cryptographic lineage continuity record. The PCSM framework addresses platform-level content safety enforcement; the present disclosure is an enterprise and government communication governance architecture enforcing pre-decryption, artifact-bound, state-machine-governed access control.

### SUMMARY OF THE INVENTION

### Technical Problem

The technical problem addressed by the present disclosure is the absence, in conventional communication architectures, of: a formally defined multi-state communication state machine with artifact-bound state-transition validation logic; a mandatory artifact-based admission evaluation enforced prior to decryption-key release with defined failure enforcement behavior; tamper-evident, cryptographically signed verifiable receipts for state transitions and governance events providing non-repudiable audit evidence; cryptographic profile compliance enforced as a state-machine-gated prerequisite; lineage-bound constraint propagation across derived communications; and dynamic post-release access modification with bounded revocation enforcement latency.

### Technical Solution

The present disclosure introduces a multi-plane, state-machine-governed communication control architecture. A state transition controller maintains a formally defined communication state machine for each communication object. Each state transition requires validation of state-transition preconditions stored in association with the message authority artifact, establishing non-bypassable enforcement of state-transition validation such that no state transition to a more permissive state occurs without affirmative validation of the applicable artifact-encoded preconditions by the state transition controller.

Upon failure of the admission evaluation, the system enforces defined failure behavior: the communication object is retained in the first communication plane without exposure of the encrypted content to any recipient system or process; no decryption keys are released; and a tamper-evident failure record is generated and appended to the verifiable audit log. This defined failure enforcement behavior prevents bypass through partial implementation and ensures that failed admission produces no content exposure side-effect.

A verifiable receipt generator produces cryptographically signed, tamper-evident records for each governed state transition and governance event, including admission, release, post-release modification, revocation, and failure events. These verifiable receipts provide non-repudiable audit evidence of the conditions under which access to encrypted content was granted, modified, or revoked, supporting enterprise compliance, regulatory accountability, and forensic investigation.

### Security Performance Improvements

The present disclosure produces measurable, technically grounded security performance improvements over conventional communication architectures. Eight independently identifiable threat categories are addressed by the mechanisms of the present disclosure; each is described with the specific mechanism by which the present disclosure eliminates or materially reduces the threat.

### A. Business Email Compromise and Compromised Sender Domain

Business Email Compromise (BEC) and related attacks in which an adversary controls a legitimate-appearing or legitimately-authenticated sender domain represent one of the highest-impact threat categories in enterprise and government communications. A compromised contractor or partner domain passes DKIM, SPF, and DMARC authentication with valid signatures. All existing gateway filtering systems accept the communication because it is technically valid from a transport-authentication standpoint. The adversary's communications are indistinguishable from legitimate communications at the transport layer.

The present disclosure eliminates this threat class at the admission layer. The sender_authority_id field in the message authority artifact must match an approved entry in the recipient domain's CommunicationAdmissionMatrix for the specified message class and cryptographic profile. A compromised domain that has no admission record, or that presents a message class not authorized for that sender under the applicable matrix, receives a hard-fail admission result. No content is exposed. A tamper-evident failure receipt is generated. The compromise is detected and evidenced without any content reaching the recipient.

### B. Post-Compromise Retroactive Revocation

When a trusted sender is compromised and communications have already been delivered and read by recipients before the compromise is detected, no existing communication protocol provides a mechanism to revoke access to already-delivered content. Certificate revocation using CRL or OCSP affects only future operations. Communications that were decrypted before the revocation event remain readable and remain in recipient inboxes.

The present disclosure provides the first protocol-level mechanism for retroactive access revocation with bounded enforcement latency. Upon detection of a qualifying post-release event, including a SENDER_COMPROMISE_INDICATOR published by a threat intelligence service, the post-release enforcement module signals the state transition controller to roll back the communication state machine for all affected communication objects and directs the hardware-security-module-bound key management service to invalidate the associated decryption keys within the hardware boundary. Revocation enforcement is complete within the propagation latency of the key management service, architecturally independent of whether the recipient endpoint cooperates. The adversary who has compromised an endpoint cannot prevent key invalidation because the key material is inside a FIPS 140-2 Level 3 hardware security module that the endpoint does not control.

### C. Harvest-Now Decrypt-Later Attacks on Archived Communications

Nation-state adversaries collect encrypted communications at scale with the intent to decrypt them retrospectively when quantum computing capability becomes available. Classical RSA and elliptic curve cryptographic algorithms will be broken by a cryptographically relevant quantum computer. All archived ciphertext protected only by classical algorithms becomes retroactively readable.

The present disclosure enforces hybrid post-quantum cryptographic profile compliance as a state-machine-gated admission prerequisite. The CryptoProfileSpec field in the message authority artifact encodes a requirement for simultaneous satisfaction of a classical algorithm component (ECDSA P-384) and a post-quantum algorithm component (ML-DSA-65, OID 2.16.840.1.101.3.4.3.18, NIST FIPS 204, RFC 9881) for signing, and a hybrid ML-KEM-768 (OID 2.16.840.1.101.3.4.4.2, NIST FIPS 203, RFC 9935) plus P-384 ECDH configuration for key encapsulation. A communication that presents only a classical cryptographic profile cannot advance from the admission-pending state regardless of algorithmic signature validity. The downgrade_prevention_floor field prevents any profile weaker than the approved minimum, encoding a minimum-approved assurance level that represents the lowest cryptographic strength permissible for state machine advancement under the applicable policy. This enforces that all admitted communications are resistant to future quantum decryption.

### D. AI Agent and Machine-Originated Communication Abuse

AI agents and automated workloads increasingly generate and process enterprise and government communications. A compromised or malicious AI agent can generate communications asserting authority beyond its permitted scope, inject unauthorized content into existing threads, forward communications to unauthorized parties, or escalate from a permitted summarization role to an unauthorized authorization role.

The present disclosure governs AI-agent-originated and machine-generated derived communications through the lineage tracking module and the max_authority_ceiling_ai_agent field of the LineageControl structure. Any derived communication originating from an AI agent that asserts authority exceeding the encoded ceiling—for example, asserting the authority to authorize a payment when the ceiling permits only summarization—is denied state machine advancement before the admission control engine evaluates it. A tamper-evident lineage violation receipt is generated recording the asserted authority scope, the ceiling value, the agent identifier, and the communication object identifiers.

### E. Thread Hijacking and Reply Injection

Adversaries conducting BEC campaigns frequently insert themselves into existing legitimate communication threads. A reply that continues an existing thread appears credible to recipients because it references prior genuine communications. No existing protocol verifies that a reply is a legitimate continuation of its parent communication or that the replying party is in the authorized participant set for that communication thread.

The present disclosure enforces cryptographic lineage continuity for all derived communications. The lineage tracking module evaluates every reply, forward, and delegation against the cryptographic lineage continuity record generated at the admission of the root communication object. A reply from a sender not in the authorized_participant_set, or presenting a lineage_id that does not match the thread's lineage record, is denied state machine advancement. The integrity of the communication thread is enforced cryptographically, not by heuristic analysis.

### F. Malicious Attachment Delivery and Ransomware

Ransomware and malware are delivered via email attachments at high volume. Sandbox scanning detects known signatures but fails against novel variants and zero-day exploits. Once a message is delivered and opened, the attachment is in the recipient's operating environment and can execute.

The present disclosure provides per-attachment release control through the encrypted_attachments structure and the attachment_release_rule field, which references a ReleaseCondition that may differ from the body release condition. Attachments of content_type_class EXECUTABLE or ARCHIVE may be configured to require secondary authorization before release, regardless of whether the message body has been released. The PARTIALLY RELEASED state permits the recipient to access the message body while attachments remain in the second communication plane pending attachment-specific release conditions. This structurally stages attachment release, providing an additional evaluation opportunity before executable content reaches the recipient environment.

### G. Insider Exfiltration Via Unauthorized Forwarding

An authorized recipient who has legitimately received a sensitive communication may forward it to unauthorized parties, either through negligence or malicious intent. Conventional IRM and DLP systems attempt to prevent forwarding through policy enforcement after delivery, but such controls depend on the recipient's mail client respecting the policy and can be circumvented by recipients taking screenshots or using alternate mail clients.

The present disclosure enforces forwarding restrictions at the admission layer of the second communication plane, not through client-side policy enforcement. A derived communication—a forward—from a recipient that names a non-authorized participant as the next recipient cannot advance from the admission-pending state in the second communication plane. The authorized_participant_set and permitted_message_classes fields of the lineage continuity record are evaluated at each derivation step. This enforcement occurs at the protocol layer and does not depend on any client-side control or the recipient's cooperation.

### H. Absence of Non-Repudiable Compliance Audit Evidence

Regulated industries and government agencies must demonstrate that sensitive communications were accessed only by authorized parties under verified conditions at specific times. Conventional communication systems produce log entries in server-side logs that are alterable and do not constitute cryptographically verifiable evidence of governance events. An adversary or insider who has access to log infrastructure can modify or delete log entries. No existing standard communication protocol generates tamper-evident, cryptographically signed records of every access governance event as an integral protocol function.

The present disclosure generates a cryptographically signed, tamper-evident verifiable receipt for every governed state transition and governance event, including admission events, failed admission events, state machine advancement events, release events, partial-release events, post-release modification events, revocation events, and expiration events. Each receipt is digitally signed by the verifiable receipt generator using a signing key maintained within the hardware security module boundary, and is appended to a hash-chained audit log replicated across a minimum of three nodes. The hash chain provides mathematical proof that no receipt has been modified or deleted; any modification invalidates the chain from the altered entry forward. As used herein, canonical bytes means the complete binary serialization of a receipt record in its stored representation prior to any transport encoding, such that each receipt's chain-hash field is computed over the identical byte sequence stored in the audit log. This constitutes non-repudiable compliance audit evidence at a level not achievable by any conventional communication system.

### Summary of Security Performance Improvements

The following table summarizes the architectural distinctions between the present disclosure and all existing communication security protocols across five security-critical dimensions.

| Dimension | All existing protocols | Present disclosure |
|---|---|---|
| Trust event | One-time: key possession, | Continuous: artifact-bound state machine |
| | signature verification, or | advancement with precondition |
| | point-of-access | validation at every transition throughout |
| | authentication. Trust is | the full communication lifecycle. |
| | established once and not re- | |
| | evaluated. | |
| Operational | Transit-time (TLS, DKIM) or | Entire lifecycle: compose through |
| timing | point-of-access (S/MIME | admitted through released through |
| | verification, portal | revoked or expired. The admission and |
| | authentication). No | release gates operate after delivery and |
| | mechanism operates after | before any decryption. |
| | delivery and before access. | |
| Revocation | Forward-only: certificate | Retroactive: HSM key invalidation |
| mechanism | revocation (CRL, OCSP) | directed by the post-release enforcement |
| | affects future operations only. | module withdraws access to already- |
| | Session termination ends | delivered content within bounded |
| | active connections. No | enforcement latency, independent of |
| | mechanism withdraws access | recipient endpoint behavior. |
| | to already-delivered or | |
| | already-decrypted content. | |
| Audit evidence | None mandated at the | Cryptographically signed, tamper-evident |
| | protocol level. Server-side | verifiable receipts for every state |
| | log entries are alterable and | transition, appended to a hash-chained |
| | do not constitute | audit log replicated across multiple |
| | cryptographically verifiable | nodes. Non-repudiable by design. |
| | governance event records. | |
| Governance | In the protocol engine, policy | In the communication object itself. The |
| location | server, gateway, or IRM | message authority artifact is |
| | platform - external to and | cryptographically bound to the encrypted |
| | separable from the | content and travels with the |
| | communication object. Policy | communication object. Governance |
| | can be bypassed by routing | cannot be separated from the content |
| | around the enforcement | without breaking integrity verification. |
| | point. | |

### Improvement to Computer Functionality

The present disclosure constitutes a specific improvement to the technical operation of computing systems by: (i) introducing a formally defined multi-state communication state machine with artifact-bound state-transition validation logic, enabling computing systems to enforce independently governed, non-collapsible protocol states; (ii) eliminating the pre-decryption attack surface by conditioning decryption-key release on artifact-validated state machine advancement; (iii) defining and enforcing specific system behavior upon failed admission, including content quarantine and tamper-evident failure logging, preventing bypass through partial implementation; (iv) generating cryptographically signed, tamper-evident verifiable receipts for all governance events, enabling non-repudiable audit evidence not producible by conventional systems; (v) enforcing cryptographic profile compliance as a state-machine-gated admission prerequisite; and (vi) enabling persistent lineage-bound constraint propagation across derived communications including AI-agent-generated communications. The present disclosure is not a policy enforcement layer that applies rules to content after acceptance into an existing communication environment; it is a protocol-level execution constraint system in which decryption-key release by the hardware-security-module-bound key management service is conditioned on affirmative state machine advancement through artifact-evaluated precondition records, and in which every governance event is mechanically enforced and cryptographically evidenced as an integral function of the protocol itself.

### BRIEF DESCRIPTION OF THE DRAWINGS

FIG. 1 is a high-level architectural diagram illustrating the dual-plane communication control system (100) including the first communication plane (106) configured for delivery of a communication object and the second communication plane (108) configured for state-machine-governed admission and release of encrypted content (102).

FIG. 2 is a block diagram of the message authority artifact (104) illustrating fields encoding authorization conditions, release conditions, cryptographic profile specification, state-transition precondition records, a lineage control parameter set, revocation or downgrade rules, and the cryptographic binding mechanism linking the artifact (104) to the encrypted content (102).

FIG. 3 is a block diagram of the admission control engine illustrating artifact-based evaluation of authorization conditions, cryptographic profile validation by the cryptographic validation module, determination of recipient eligibility, and generation of a tamper-evident admission event receipt, all performed without decryption of encrypted content.

FIG. 4 is a formal state diagram of the communication state machine maintained by the state transition controller, illustrating states comprising delivered, admission-pending, admitted, release-qualified, released, partially-released, reevaluation-pending, revoked, and expired, and showing artifact-stored state-transition preconditions validated for each state transition.

FIG. 5 is a flow diagram illustrating the admission evaluation process including evaluation of message authority artifact authorization conditions, cryptographic profile validation, recipient eligibility determination, state machine advancement upon successful evaluation, and defined failure enforcement behavior including quarantine and tamper-evident failure receipt generation upon failed evaluation.

FIG. 6 is a block diagram showing the state transition controller enforcing formal state separation, validating artifact-encoded state-transition preconditions for each transition, and conditioning decryption-key release by the hardware-security-module-bound key management service on state machine advancement to the released state.

FIG. 7 is a flow diagram showing the lineage tracking module (120) enforcing lineage-bound constraints across derived communications via a lineage continuity record (136), including detection of unauthorized participant introduction, authority scope escalation in AI-agent-originated communications, and cryptographic-profile downgrade.

FIG. 8 is a flow diagram showing the post-release enforcement module performing post-release control operations including state machine rollback, decryption-key revocation through the hardware-security-module-bound key management service, access downgrade, and tamper-evident post-release event receipt generation.

FIG. 9 is a system block diagram showing the ingress gateway (110), admission control engine (112), cryptographic validation module (114), state transition controller (116), lineage tracking module (120), post-release enforcement module (122), verifiable receipt generator (124), audit log (126), hardware-security-module-bound key management service (128), and replicated state store (130) operating within the dual-plane architecture.

FIG. 10 is a block diagram illustrating the verifiable receipt generator producing cryptographically signed, tamper-evident receipts for state transitions and governance events, and the tamper-evident audit log storing receipts for admission, release, post-release modification, revocation, and failure events.

FIG. 11 is a block diagram of the communication admission matrix (152) including admission records and state-transition precondition records associated with the message authority artifact (104), illustrating the inseparable linkage among the artifact, the state machine, and the transition validation logic.

FIG. 12 is a block diagram illustrating cryptographic profile validation including post-quantum algorithm requirements, hybrid classical-plus-post-quantum requirements, hardware-root attestation, and downgrade-prevention enforcement as state-machine-gated admission prerequisites.

FIG. 13 is a block diagram showing sovereign and air-gapped deployment topology with distributed state machine enforcement and air-gap-traversable trust-update package verification.

FIG. 14 is a flow diagram illustrating release-precondition evaluation performed by the state transition controller (116), including evaluation of device posture, identity assurance level, execution environment integrity, and biometric step-up verification as state-transition preconditions for advancement from the admitted state to the released state. In some embodiments, one or more release preconditions evaluated at the admitted-to-released transition may overlap in subject matter with admission evaluation criteria evaluated at the admission-pending-to-admitted transition; in such embodiments the state transition controller independently evaluates the applicable precondition record stored in association with the message authority artifact at each governed state transition.

FIG. 15 is a data structure diagram illustrating the complete message authority artifact field schema (104), the outer delivery component data structure (132), the inner content component data structure (134), and the cryptographic binding record linking the artifact to the encrypted content, as described in Section 4 of the Detailed Description.

FIG. 16 is a block diagram illustrating a federated multi-domain admission control architecture in which a first restricted recipient domain and a second restricted recipient domain each maintain sovereign communication admission matrices, and cross-domain communication is governed by mutual trust descriptors exchanged between domain admission authorities, wherein each domain independently evaluates admission conditions and neither domain is required to accept communications admitted by the other domain without independent admission evaluation.

### DETAILED DESCRIPTION OF THE PREFERRED EMBODIMENTS

### 1. Overview and Scope

The following detailed description is presented to enable any person skilled in the art of secure communications systems, cryptographic protocol design, and distributed computing to make and use the claimed subject matter without extensive experimentation. For purposes of explanation, specific details are set forth to provide a thorough understanding of the present disclosure. Various modifications to the preferred embodiments will be readily apparent to those skilled in the art without departing from the scope of the invention as defined by the appended claims. References herein to “the preferred embodiment,” “in the preferred embodiment,” or “the preferred best mode” identify one or more concrete implementations selected for purposes of disclosure and do not limit the scope of the claims or constitute a disclaimer of any subject matter described but not expressly recited in the claims. Any feature described in connection with a preferred embodiment may be combined with, replaced by, or omitted in favor of any alternative feature consistent with the architectural relationships disclosed herein.

The present disclosure may be referred to as a Verifiable Enterprise Messaging Protocol (VEMP). A communication object, as used herein, may comprise an email message, a secure message object, a routed notification, a delegated communication, a machine-originated communication, an AI-agent-originated communication, a reply, a forward, or any other electronic communication event associated with a message authority artifact. All examples of field values, byte lengths, algorithm identifiers, and timing parameters set forth herein are illustrative of the preferred embodiment and do not limit the scope of the claims.

In some embodiments, the disclosed architecture is implemented using alternative cryptographic primitives, alternative object encodings, alternative attestation mechanisms, alternative key-establishment techniques, alternative key-management infrastructures, or alternative release-control mechanisms, provided that such implementations preserve one or more of the disclosed architectural relationships comprising: admission evaluation prior to decryption-key release; validation of state-transition preconditions stored in association with a communication-governing artifact or functionally equivalent control structure; state-machine-governed advancement to a release state prior to content access; lineage-bound enforcement for derived communications; and post-release control operations including rollback, downgrade, or key invalidation.

Accordingly, the present disclosure is not limited to any particular named algorithm, cryptographic suite, standards designation, parameter set, object serialization format, or attestation format unless expressly recited in a claim. References herein to ECDSA, ECDH, ML-DSA, ML-KEM, Kyber, ASN.1 DER, JSON-LD, JWS, TPM attestation, enclave attestation, or other named technologies are provided as illustrative embodiments supporting enablement of the disclosed architecture and shall not be construed as limiting.

### 2. Definitions

“First communication plane” means a communication channel, transport layer, or routing environment configured for delivery of a communication object without exposing encrypted content or enabling content access as a consequence of delivery. In one embodiment, the first communication plane may be implemented as a standards-compliant SMTP/MIME channel carrying an outer envelope component that contains no substantive protected content. The first communication plane is not limited to any particular transport protocol; alternative embodiments may use any delivery channel capable of routing the outer delivery component without exposing the inner content component.

“Second communication plane” means a controlled-access environment governed by a state machine, configured for artifact-based evaluation of admission conditions and controlled release of encrypted content, operating independently of and architecturally separated from the first communication plane. The second communication plane is not reachable by delivery of the outer envelope component alone; entry requires presentation of the message authority artifact to the admission control engine.

“Message authority artifact” means a structured data object that is cryptographically bound to a communication object, that stores state-transition precondition records evaluated by the state transition controller for each state transition, and that is required for state machine advancement from the admission-pending state. The message authority artifact is not optional metadata; it is a mandatory component whose absence or integrity failure prevents state machine advancement and whose state-transition precondition records are evaluated for each transition, establishing artifact-bound state-transition enforcement such that the artifact, the state machine, and the validation logic operate as a coordinated system.

“State transition controller” means a hardware or software component comprising a state transition validation engine configured to execute deterministic validation logic against artifact-stored precondition records for each proposed state transition. The state transition controller maintains a formally defined communication state machine for each communication object, and the state transition validation engine retrieves and evaluates the state-transition precondition records stored in association with the message authority artifact before authorizing any state transition.

“Admission control engine” means a hardware or software component configured to perform an admission evaluation without decrypting the encrypted content, by evaluating authorization conditions encoded in the message authority artifact, coordinating with the cryptographic validation module, and determining recipient eligibility.

“Admission evaluation” means a process performed in the second communication plane prior to decryption-key release, comprising evaluation of artifact-encoded authorization conditions, cryptographic profile validation, and recipient eligibility determination.

“Failure enforcement behavior” means the defined system response to a failed admission evaluation, comprising: mandatory retention of the communication object in the first communication plane without any exposure of the encrypted content to any recipient system or process; prevention of any decryption-key release; and generation of a tamper-evident failure receipt by the verifiable receipt generator, appended to the audit log.

“Release state” means a formally defined protocol state of the communication object in which the state transition controller has validated all release preconditions stored in association with the message authority artifact and has authorized decryption-key release by the hardware-security-module-bound key management service.

“Verifiable receipt” means a cryptographically signed, tamper-evident record generated by the verifiable receipt generator for a governed state transition or governance event, comprising event type, event time, communication object identifier, actor identity, cryptographic profile in effect, state machine state at the time of the event, and a digital signature over the record, stored in a tamper-evident audit log.

“Lineage-bound constraint” means an authorization condition, cryptographic constraint, or access limitation inherited by a derived communication object from a parent communication object through a cryptographic lineage continuity record (136) maintained by the lineage tracking module (120).

“Post-release control operation” means an operation performed by the post-release enforcement module after the communication object has entered the release state, comprising at least one of state machine rollback, decryption-key revocation through the hardware-security-module-bound key management service, access downgrade, or rendering replacement, accompanied by generation of a tamper-evident post-release event receipt.

“Cryptographic profile” means one or more algorithmic, provenance, or assurance requirements evaluated as state-machine-gated admission prerequisites independent of algorithmic signature validity.

Abbreviations and Acronyms. As used in this specification, the following abbreviations have the meanings set forth below: AAD means additional authenticated data; AES means Advanced Encryption Standard; AI means artificial intelligence; API means Application Programming Interface; CEK means content encryption key; COSE means CBOR Object Signing and Encryption; CRL means Certificate Revocation List; DKIM means DomainKeys Identified Mail; DLP means Data Loss Prevention; DMARC means Domain-based Message Authentication, Reporting and Conformance; DN means distinguished name; DRBG means deterministic random bit generator; ECDH means Elliptic Curve Diffie-Hellman; ECDSA means Elliptic Curve Digital Signature Algorithm; FIPS means Federal Information Processing Standard; HKDF means HMAC-based Key Derivation Function; HSM means hardware security module; HTTPS means Hypertext Transfer Protocol Secure; IAL means Identity Assurance Level; IEEE means Institute of Electrical and Electronics Engineers; IETF means Internet Engineering Task Force; IRM means Information Rights Management; JWS means JSON Web Signature; KEM means Key Encapsulation Mechanism; KMS means key management service; MTA means Mail Transfer Agent; NIST means National Institute of Standards and Technology; OCSP means Online Certificate Status Protocol; OID means object identifier; PQC means post-quantum cryptography; RFC means Request for Comments; SHA means Secure Hash Algorithm; SIEM means Security Information and Event Management; SMTP means Simple Mail Transfer Protocol; SPF means Sender Policy Framework; TLS means Transport Layer Security; TPM means Trusted Platform Module; URI means Uniform Resource Identifier; UUID means Universally Unique Identifier; ZTA means Zero Trust Architecture.

“Revocation rules” means one or more rules encoded in the message authority artifact specifying qualifying post-release events and corresponding enforcement operations, each rule comprising a trigger condition type, a trigger condition value, and a revocation action evaluated by the post-release enforcement module to initiate state machine rollback and decryption-key invalidation by the hardware-security-module-bound key management service.

“Downgrade prevention floor” means a minimum acceptable cryptographic algorithm strength encoded in the message authority artifact as a lower bound on the cryptographic profile of any communication object or derived communication object admitted to the second communication plane, enforced by the state transition controller such that no communication object presenting a cryptographic profile weaker than the encoded floor may advance from the admission-pending state regardless of other admission condition results.

### 3. System Architecture—Concrete Implementation

In the preferred embodiment, the system may be implemented to comprise the following hardware and software components. The enumeration below describes one concrete implementation sufficient to enable the claimed subject matter and does not limit the scope of the claims, which may be practiced with alternative implementations preserving the architectural relationships described herein.

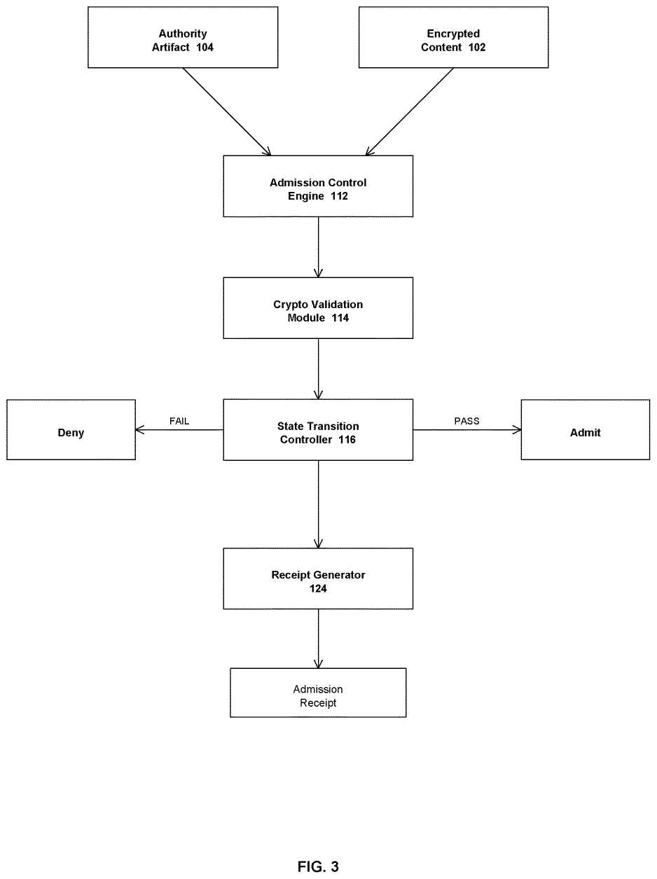

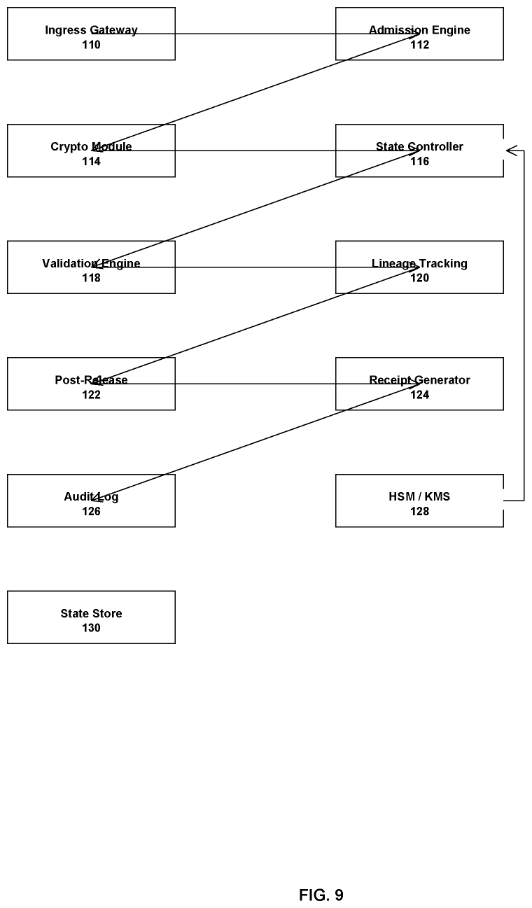

Referring to FIG. 3 and FIG. 9, The ingress gateway (110) receives communication objects (100) in the first communication plane (106) and separates each into an outer delivery component (132) retained in the first communication plane (106) and an inner content component (134) comprising the encrypted content (102) and the cryptographically bound message authority artifact (104), forwarded to the second communication plane (108).

The admission control engine performs an admission evaluation without decrypting the encrypted content. Upon completion, it signals the state transition controller with a pass or fail result. The admission control engine does not release decryption keys under any circumstances; in the preferred embodiment, decryption-key release is performed exclusively by the hardware-security-module-bound key management service upon authorization from the state transition controller, consistent with the system claim requiring that the hardware security module releases keys solely upon explicit authorization from the state transition controller.

The cryptographic validation module validates the cryptographic profile against an approved cryptographic policy, evaluating algorithm family compliance, hardware-root attestation evidence, post-quantum algorithm compliance, hybrid classical-plus-post-quantum compliance, and downgrade-prevention compliance, returning a pass or fail result regardless of algorithmic signature validity.

The state transition controller (116) comprises a state transition validation engine (118) configured to execute deterministic validation logic against artifact-stored precondition records for each proposed state transition. State machine state for each communication object is persisted in a replicated state store (130) distributed across a minimum of three nodes using the Raft consensus protocol. The communication state machine comprises the following defined states: delivered, admission-pending, admitted, release-qualified, released, partially-released, reevaluation-pending, revoked, and expired.

The hardware-security-module-bound key management service generates, stores, and manages decryption keys in a tamper-resistant hardware boundary, releases keys exclusively upon authorization from the state transition controller in the preferred embodiment, and executes key invalidation within the hardware boundary without endpoint cooperation.

### 4. Message Authority Artifact-Complete Field Schema

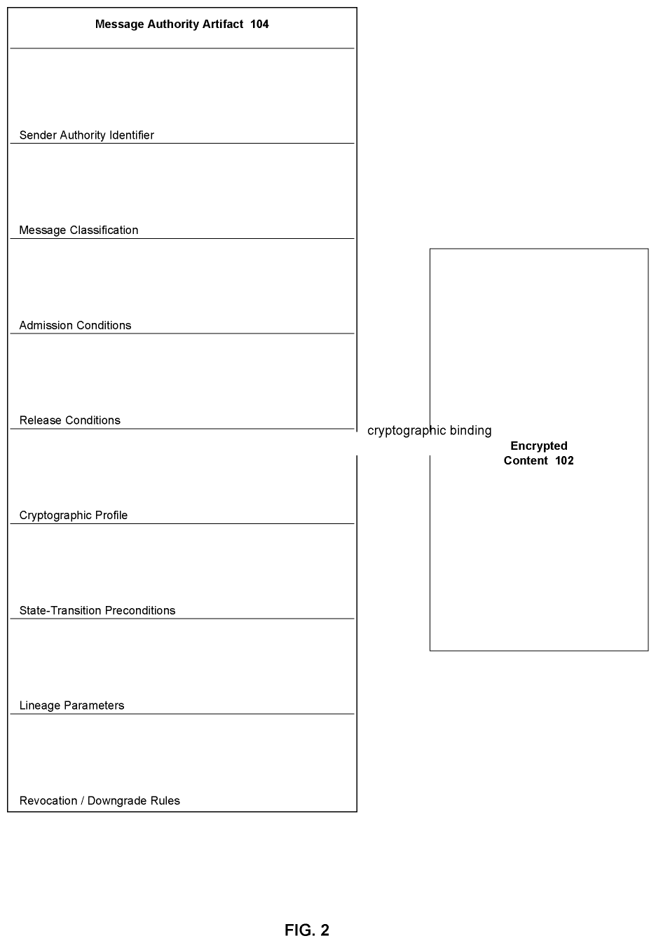

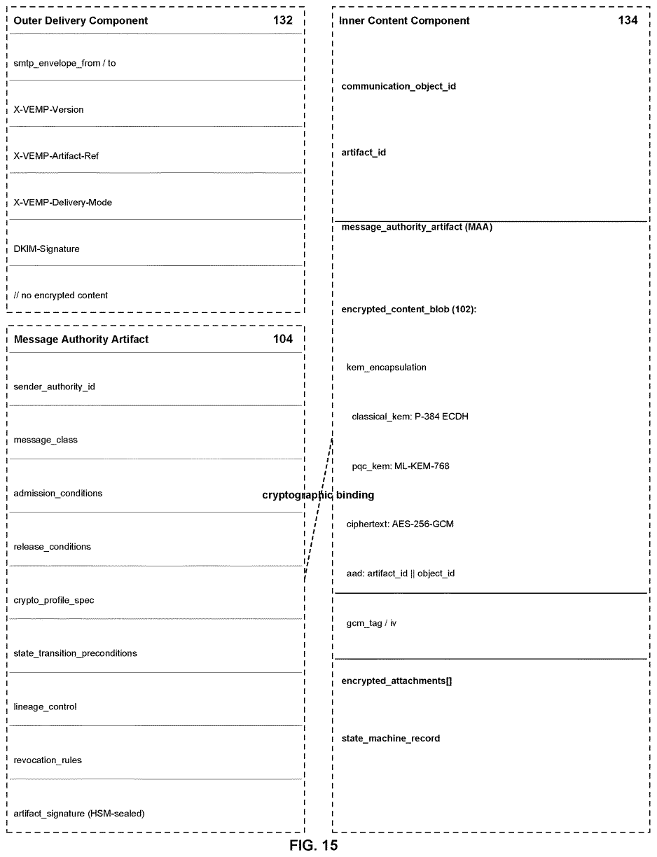

The message authority artifact is a structured binary object serialized in a defined encoding (ASN.1 DER in the preferred embodiment, JSON-LD with JWS envelope in alternative embodiments) and cryptographically bound to the encrypted content object. FIG. 2 and FIG. 15 illustrate the artifact structure. The following field schema defines all mandatory and optional fields. A person of ordinary skill in the art of secure protocol design will recognize the field types as standard constructions implementable using widely available cryptographic libraries including OpenSSL 3.x, BouncyCastle, and NIST-reference implementations.

In alternative embodiments, the communication-governing structure need not be limited to a single binary artifact in ASN.1 DER form. The structure may be implemented as a signed or authenticated policy object, control token, authority envelope, governance manifest, release descriptor, cryptographically linked metadata structure, or other functionally equivalent machine-readable control object storing or referencing the preconditions governing admission, release, lineage, revocation, downgrade, or reevaluation. In such embodiments, the control structure may be embedded within, attached to, transmitted alongside, referenced by, or cryptographically bound to the communication object, provided that integrity failure, absence of the control structure, or failure of control-structure validation prevents advancement to a more permissive communication state.

In further embodiments, cryptographic binding between the control structure and the encrypted content may be implemented using one or more of: a digest binding, signature binding, message authentication code binding, authenticated-encryption associated-data binding, certificate-linked binding, hardware-attested binding, or other integrity-preserving linkage sufficient to cause unauthorized modification, substitution, removal, or weakening of the control structure to be detectable by the admission control engine, the state transition controller, or both.

Table 1 sets forth the mandatory fields of the message authority artifact.

| | Type / | | |
|---|---|---|---|
| Field Name | Length | Description | Constraint |
| artifact_id | UUID v4 | Globally unique artifact | MUST be unique per |
| | (128 bits) | identifier. Used as the | communication object. |
| | | primary key in the state | MUST be generated by |
| | | management store and in all | a FIPS-compliant |
| | | verifiable receipts. | DRBG. |
| artifact_version | UINT8 | Schema version. Current | MUST be 0x02 for this |
| | | value: 0x02. | specification. Values |
| | | | 0x00 and 0x01 are |
| | | | reserved for legacy |
| | | | migration. |
| communication_{—} | SHA-256 | Hash of the encrypted | MUST match the SHA- |
| object_id | hash (256 | content blob to which this | 256 digest of the |
| | bits) | artifact is bound. Computed | associated encrypted |
| | | over the ciphertext bytes | content. Mismatch |
| | | before artifact sealing. | causes automatic |
| | | | integrity failure. |
| sender_authority_{—} | UTF-8 string, | Canonical identifier of the | MUST match the |
| id | max 256 | sender authority: | subject DN of the |
| | bytes | organization DN from the | sender authority |
| | | sender's authority certificate, | certificate in |
| | | e.g. | sender_authority_cert_{—} |
| | | ‘O = NavyCommand, OU = CryptoOps, | chain. |
| | | C = US’. | |
| sender_role_id | UTF-8 string, | Role identifier of the | MUST be drawn from |
| | max 128 | originating sender, e.g. | the approved role |
| | bytes | ‘PROCUREMENT_OFFICER’, | registry of the sender |
| | | ‘AI_AGENT_CLASS_B’. | authority. |
| message_class | UINT16 | Message class code. | MUST match an entry |
| | enum | 0x0001 = GENERAL, | in the recipient |
| | | 0x0002 = OPERATIONAL, | domain's |
| | | 0x0003 = PROCUREMENT, | Communication |
| | | 0x0004 = PAYMENT_INSTRUCTION, | Admission Matrix. |
| | | 0x0005 = EXECUTIVE, | |
| | | 0x00FF = CLASSIFIED_SOVEREIGN. | |
| admission_{—} | SEQUENCE | One or more admission | MUST contain at least |
| conditions | OF | conditions that must evaluate | one condition. All |
| | AdmissionCondition | TRUE for state machine | conditions are evaluated |
| | | advancement from | conjunctively unless |
| | | admission-pending to | disjunction_group_id |
| | | admitted. See | fields are set. |
| | | AdmissionCondition | |
| | | structure below. | |
| release_conditions | SEQUENCE | One or more release | MUST contain at least |
| | OF | conditions governing state | one condition. May |
| | ReleaseCondition | machine advancement from | include |
| | | admitted to release-qualified | biometric_step_up_{—} |
| | | or released. | required = TRUE for |
| | | | elevated-assurance |
| | | | message classes. |
| crypto_profile_id | UTF-8 string, | Identifier of the required | MUST match a profile |
| | max 64 bytes | cryptographic policy profile, | entry in the recipient |
| | | e.g. ‘GOV-HYBRID-PQ-1’, | domain's |
| | | ‘ENTERPRISE-SECURE-3’. | CryptoProfileRegistry. |
| | | | Mismatch causes |
| | | | cryptographic |
| | | | validation failure. |
| crypto_profile_spec | CryptoProfile | Inline specification of | MUST be consistent |
| | Spec | required algorithms, key | with crypto_profile_id. |
| | structure | provenance, and downgrade- | Controls behavior when |
| | | prevention constraints. See | profile registry is |
| | | CryptoProfileSpec below. | unavailable. |
| lineage_control | LineageControl | Parameters governing | REQUIRED for all |
| | structure | constraint inheritance by | communications that |
| | | derived communications. See | may generate replies, |
| | | LineageControl below. | forwards, or AI-agent |
| | | | responses. |
| revocation_rules | SEQUENCE | One or more rules specifying | MUST contain at least |
| | OF | qualifying post-release | one rule specifying the |
| | RevocationRule | events that trigger post- | behavior upon |
| | | release control operations. | sender_compromise_{—} |
| | | | indicator detection. |
| sender_authority_{—} | SEQUENCE | Full certificate chain from | MUST be verifiable to |
| cert_chain | OF X.509 | sender authority leaf | a trust anchor in the |
| | Certificate | certificate to trust anchor. | recipient domain's |
| | (DER) | Minimum chain depth: 2 | TrustAnchorStore. |
| | | (leaf + root). | |
| artifact_seal_{—} | GeneralizedTime | UTC timestamp at which the | MUST be within |
| timestamp | (ASN.1) | artifact was sealed within the | acceptable clock skew |
| | | HSM. | tolerance of recipient |
| | | | system time (default: |
| | | | 300 seconds). |
| artifact_signature | ECDSA P- | Signature over all preceding | MUST verify against |
| | 384 + ML- | fields, computed within the | the public key in |
| | DSA-65 | HSM using the artifact- | sender_authority_cert_{—} |
| | hybrid | sealing key. In hybrid mode, | chain leaf certificate. |
| | signature | both signature values are | Verification failure |
| | (RFC 9881) | concatenated and the | causes immediate |
| | | combined length is 48 + | integrity failure |
| | | 2420 = 2468 bytes for this | independent of all other |
| | | profile. | field values. |

Table 2 sets forth the AdmissionCondition structure
used in the admission_conditions field.

| Sub-Field | Type | Description |
|---|---|---|
| condition_type | UINT8 enum | 0x01 = SENDER_ORG_AUTHORIZED: |
| | | sender_authority_id must match an entry in the |
| | | recipient's CommunicationAdmissionMatrix. |
| | | 0x02 = SENDER_ROLE_AUTHORIZED: |
| | | sender_role_id must match an authorized role |
| | | for the message_class in the matrix. |
| | | 0x03 = CRYPTO_PROFILE_COMPLIANT: |
| | | cryptographic profile must satisfy |
| | | crypto_profile_id requirements. |
| | | 0x04 = RECIPIENT_DEVICE_POSTURE: |
| | | recipient device must satisfy the |
| | | device_posture_policy_id. |
| | | 0x05 = RECIPIENT_IDENTITY_ASSURANCE: |
| | | recipient identity assurance level must meet |
| | | ial_minimum. |
| | | 0x06 = RECIPIENT_ENCLAVE_INTEGRITY: |
| | | recipient execution environment must satisfy |
| | | enclave_measurement_policy_id. |
| | | 0x07 = SENDER_CERT_VALID: sender |
| | | authority certificate chain must be valid at |
| | | evaluation time. |
| condition_value | OCTET | Encoded condition parameter. For |
| | STRING, | SENDER_ORG_AUTHORIZED: the |
| | variable | authorized organization DN pattern (UTF-8). |
| | | For RECIPIENT_DEVICE_POSTURE: the |
| | | device posture policy identifier (UTF-8). For |
| | | RECIPIENT_IDENTITY_ASSURANCE: the |
| | | minimum IAL value (UINT8, NIST SP 800-63 |
| | | scale 1-3). |
| disjunction_group_id | UINT8, optional | When set, conditions sharing the same |
| | | disjunction_group_id are evaluated disjunctively |
| | | (OR). Conditions in different groups are |
| | | evaluated conjunctively (AND). Default: 0x00 |
| | | (all conditions conjunctive). |
| failure_disposition | UINT8 enum | 0x01 = HARD_FAIL: failure of this condition |
| | | causes immediate admission failure regardless |
| | | of other conditions. 0x02 = SOFT_FAIL_LOG: |
| | | failure is logged but does not cause admission |
| | | failure (for informational conditions only). |
| | | Default: 0x01. |

Table 3 sets forth the CryptoProfileSpec structure used in the crypto_profile_spec field.

| Sub-Field | Type | Description |
|---|---|---|
| signing_algorithm_classical | OID | Required classical signing algorithm OID. |
| | | Preferred: 1.2.840.10045.4.3.3 (ecdsa- |
| | | with-SHA384 / P-384). |
| signing_algorithm_pqc | OID | Required post-quantum signing algorithm |
| | | OID. Preferred: 2.16.840.1.101.3.4.3.18 |
| | | (id-ml-dsa-65, ML-DSA-65, NIST FIPS |
| | | 204 / RFC 9881). |
| encryption_algorithm_classical | OID | Required classical key encapsulation OID. |
| | | Preferred: 1.2.840.10045.3.1.34 (P-384 |
| | | ECDH). |
| encryption_algorithm_pqc | OID | Required post-quantum KEM OID. |
| | | Preferred: 2.16.840.1.101.3.4.4.2 (id-ml- |
| | | kem-768, CRYSTALS-Kyber768, NIST |
| | | FIPS 203). |
| hybrid_mode_required | BOOLEAN | When TRUE, both classical and PQC |
| | | algorithm fields must be satisfied |
| | | simultaneously. Failure of either |
| | | component fails the profile validation. |
| hardware_root_attestation_{—} | BOOLEAN | When TRUE, sender must provide |
| required | | hardware-root attestation evidence (TPM |
| | | 2.0 quote or SGX attestation report) |
| | | referencing the artifact-sealing key. |
| downgrade_prevention_floor | OID | Minimum acceptable algorithm strength. |
| | | Any profile weaker than this floor OID |
| | | causes downgrade-prevention failure |
| | | regardless of other field satisfaction. |
| key_provenance_required | UINT8 | 0x01 = SOFTWARE_KEY_ACCEPTABLE, |
| | enum | 0x02 = HSM_GENERATED_REQUIRED, |
| | | 0x03 = FIPS_140_2_L3_REQUIRED. |
| | | Default in sovereign embodiment: 0x03. |

Table 4 sets forth the LineageControl structure governing
constraint inheritance by derived communications.

| Sub-Field | Type | Description |
|---|---|---|
| lineage_id | UUID v4 | Identifier of the lineage chain. All derived |
| | (128 bits) | communications generated from this |
| | | communication object inherit this lineage_id. |
| | | Enables cross-chain audit reconstruction. |
| parent_communication_id | UUID v4 | communication_object_id of the parent. NULL for |
| | or NULL | root communications. Non-null for replies, |
| | | forwards, and AI-agent-originated derived |
| | | communications. |
| authorized_participant_set | SEQUENCE | Canonical DNs of entities authorized to receive |
| | OF | derived communications in this lineage chain. |
| | UTF-8 | Introduction of a new participant not in this set |
| | string | requires approval from the lineage authority. |
| permitted_message_classes | SEQUENCE | Message class codes permitted for derived |
| | OF | communications. A derived communication |
| | UINT16 | asserting a message_class not in this set is denied |
| | | state machine advancement. |
| max_authority_ceiling_ai_{—} | UINT8 | Maximum authority level permitted for AI-agent- |
| agent | enum | originated derived communications: |
| | | 0x01 = READ_ONLY_SUMMARIZE, |
| | | 0x02 = REPLY_WITHIN_THREAD, |
| | | 0x03 = FORWARD_TO_AUTHORIZED_PARTICIPANTS, |
| | | 0x04 = ESCALATE_WITH_HUMAN_APPROVAL. |
| | | Default: 0x02. |
| crypto_profile_floor | UTF-8 | Minimum crypto_profile_id acceptable for derived |
| | string | communications. A derived communication |
| | | presenting a weaker profile is denied state machine |
| | | advancement. |
| lineage_depth_limit | UINT8 | Maximum number of derivation levels permitted. |
| | | A derived communication at depth exceeding this |
| | | limit is denied state machine advancement. |
| | | Default: 5. |
| lineage_authority_cert | X.509 | Certificate of the lineage authority whose signature |
| | Certificate | is required on any lineage modification event, such |
| | (DER) | as participant addition or authority ceiling |
| | | upgrade. |

### 5. Outer-Plane and Inner-Plane Data Structures

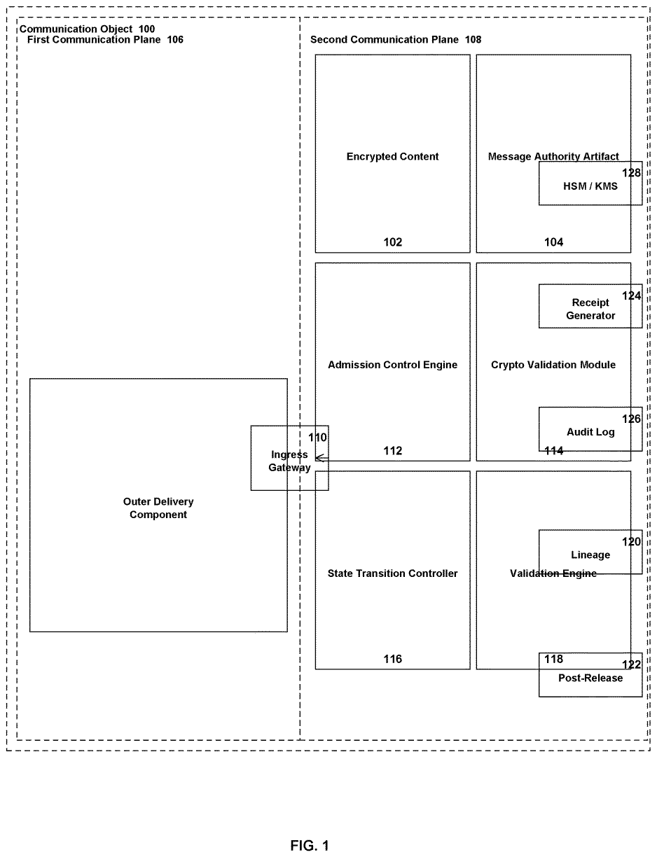

The ingress gateway (110) enforces strict separation between the outer delivery component (132) and the inner content component (134). FIG. 1 and FIG. 15 illustrate this separation. The outer delivery component (132) is retained in the first communication plane (106); the inner content component (134) is forwarded to the second communication plane (108). The outer-plane and inner-plane data structures are defined as follows.

The outer delivery component (first communication plane) contains the following fields:

OuterDeliveryComponent {

| | |
|---|---|
| smtp_envelope_from: | RFC5321 MailFrom address (UTF-8) |
| smtp_envelope_to: | RFC5321 RcptTo address (UTF-8) |

mime_headers: {

| | |
|---|---|
| From: | RFC5322 display name + address |
| To: | RFC5322 display name + address |
| Subject: | [VEMP-PROTECTED] + safe_subject_fragment (max 64 chars) |
| Date: | RFC5322 timestamp |

| | |
|---|---|
| Message-ID: | RFC5322 message ID (= communication_object_id in UUID URI |

form)

| | |
|---|---|
| X-VEMP-Version: | ‘2.0’ |

```
  X-VEMP-Artifact-Ref: artifact_id (UUID, hex-encoded, 32 chars)
  X-VEMP-Delivery-Mode: ‘NOTIFICATION’ | ‘HYBRID_PROTECTED’ |
‘INLINE_PROTECTED’
  X-VEMP-Retrieval-URI: HTTPS URI to second-plane ingress gateway (optional)
```

| | |
|---|---|
| DKIM-Signature: | Standard DKIM-SHA256 over outer headers |
| ARC-Seal: | ARC chain for forwarding integrity |

}
mime_body: {

| | |
|---|---|
| text/plain part: | Safe notification text: ‘A protected communication |

is pending your review. Artifact: <artifact_id>.’

| | |
|---|---|
| text/html part: | Branded HTML notification (no substantive content) |

```
  }
  // INVARIANT: No encrypted content, no decryption material,
  // no message authority artifact binary is present in this structure.
}
```

The inner content component (second communication plane) contains the following fields:

InnerContentComponent {
communication_object_id: UUID v4 (matches Message-ID in outer envelope)

| | |
|---|---|
| artifact_id: | UUID v4 (matches X-VEMP-Artifact-Ref in outer envelope) |

```
  message_authority_artifact: MessageAuthorityArtifact (ASN.1 DER, see Section 4)
    encrypted_content_blob: {
    encryption_algorithm: AES-256-GCM (content encryption key wrapped by KEM output)
    kem_encapsulation: {
```

| | |
|---|---|
| classical_kem: | P-384 ECDH encapsulated key (97 bytes) |
| pqc_kem: | Kyber768 encapsulated key (1088 bytes) |

| | |
|---|---|
| hybrid_kdf_output: | HKDF-SHA384 over concat(ecdh_shared_secret, |

kyber_shared_secret)
}

| | |
|---|---|
| ciphertext: | AES-256-GCM encrypted message body (variable length) |
| aad: | Additional authenticated data = artifact_id \|\| communication_object_id |
| gcm_tag: | 128-bit GCM authentication tag |
| iv: | 96-bit random IV (generated by HSM DRBG) |

```
  }
  encrypted_attachments: SEQUENCE OF {
```

| | |
|---|---|
| attachment_id: | UUID v4 |

| | |
|---|---|
| filename_hash: | SHA-256 of original filename (filename not in plaintext) |
| content_type_class: | UINT8 (0x01=DOCUMENT, 0x02=IMAGE, 0x03=ARCHIVE, |

```
0x04=EXECUTABLE)
    attachment_ciphertext: AES-256-GCM encrypted attachment bytes (separate CEK per
attachment)
    attachment_release_rule: ReleaseCondition reference (may require secondary
authorization)
  }
  state_machine_record: {
```

| | |
|---|---|
| current_state: | UINT8 (see Table 5 for state encoding) |

| | |
|---|---|
| state_last_updated: | GeneralizedTime |

```
    state_updated_by_node: node_id (UTF-8)
    replicated_node_count: UINT8 (number of nodes that have confirmed this state)
    precondition_eval_log: SEQUENCE OF PreconditionEvalRecord (one per evaluated
condition)
  }
  // INVARIANT: This structure is never transmitted in the first communication plane.
  // The encrypted_content_blob ciphertext is NOT decryptable without HSM key release.
  // The state_machine_record is authoritative; endpoint-side caches are informational only.
}
```

### 6. Communication State Machine-Formal State Transition Table

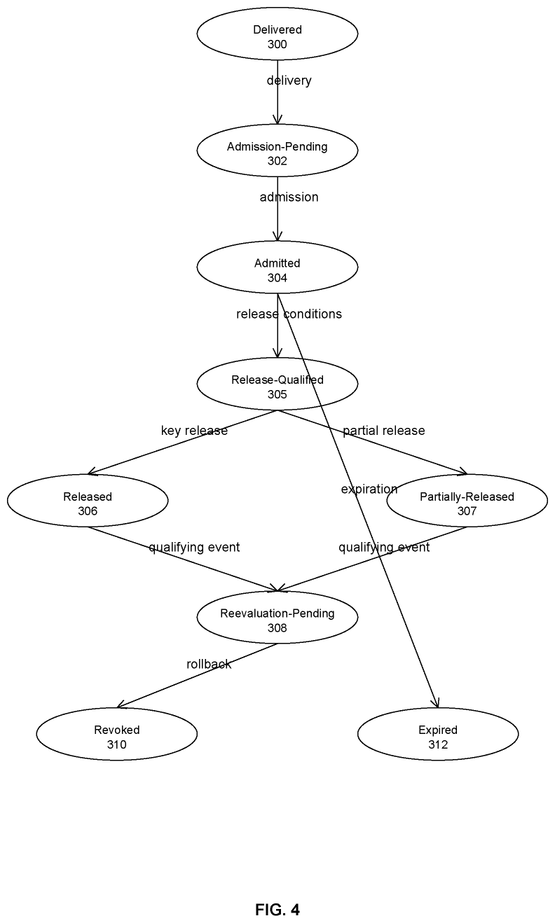

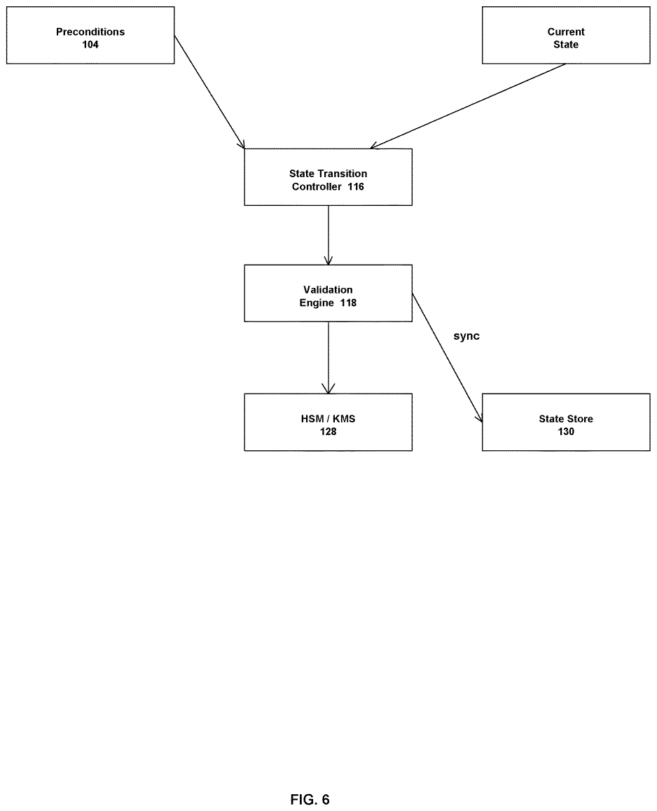

Referring to FIG. 4 and FIG. 6, The state transition controller maintains the communication state machine for each communication object. Table 5 defines the complete state encoding and Table 6 defines all valid state transitions, the preconditions required for each, and the defined behavior upon precondition failure.

TABLE 5
State encoding.

| State | | |
|---|---|---|
| Code | State Name | Description |
| 0x00 | DELIVERED | Communication object has been received at the |
| | | first communication plane boundary. No |
| | | content access is possible in this state. The |
| | | outer delivery component may be presented to |
| | | the recipient email client; the inner content |
| | | component is retained in the second |
| | | communication plane pending admission. |
| 0x01 | ADMISSION_PENDING | The communication object has been forwarded |
| | | to the second communication plane and the |
| | | admission evaluation has been initiated. The |
| | | state transition controller is awaiting results |
| | | from the admission control engine and |
| | | cryptographic validation module. No |
| | | decryption-key release is permitted in this |
| | | state. |
| 0x02 | ADMITTED | The admission evaluation has completed |
| | | successfully. The state transition controller has |
| | | validated all admission precondition records |
| | | stored in association with the message |
| | | authority artifact. Release conditions have not |
| | | yet been evaluated. |
| 0x03 | RELEASE_QUALIFIED | All release conditions have been evaluated and |
| | | satisfied. The state transition controller is |
| | | awaiting secondary authorization event |
| | | completion (if required by the |
| | | release_conditions field) before advancing to |
| | | RELEASED. |
| 0x04 | RELEASED | All release preconditions and, where required, |
| | | secondary authorization events have been |
| | | satisfied. The HSM-bound key management |
| | | service has released decryption keys to the |
| | | authorized recipient process. Content access is |
| | | permitted within the defined release context. |
| 0x05 | PARTIALLY_RELEASED | The communication object body has been |
| | | released but one or more attachments remain in |
| | | RELEASE_QUALIFIED state pending |
| | | attachment-specific release conditions. The |
| | | recipient may access the message body but not |
| | | all attachments. |
| 0x06 | REEVALUATION_PENDING | A qualifying post-release event has been |
| | | detected by the post-release enforcement |
| | | module. The state transition controller has |
| | | suspended further key release and is evaluating |
| | | whether the released state conditions remain |
| | | satisfied. |
| 0x07 | REVOKED | The state transition controller has determined |
| | | that prior release conditions are no longer |
| | | satisfied. The HSM-bound key management |
| | | service has invalidated all decryption keys. |
| | | Content is no longer accessible regardless of |
| | | prior key distribution. |
| 0x08 | EXPIRED | The communication object has exceeded its |
| | | time-bound release window as encoded in a |
| | | time-bound release condition. The state |
| | | transition controller has transitioned to |
| | | EXPIRED automatically upon expiration. Key |
| | | material is invalidated identically to the |
| | | REVOKED state. |

TABLE 6
State transition table - preconditions and failure behavior.

| | | Transition | Precondition | Failure |
|---|---|---|---|---|
| From State | To State | Trigger | Records Evaluated | Behavior |
| DELIVERED | ADMISSION_{—} | Ingress | Artifact integrity | Integrity or |
| | PENDING | gateway | check: SHA-256 of | signature |
| | | forwards | encrypted_content_{—} | failure: inner |
| | | inner | blob MUST match | content |
| | | content | communication_object_{—} | component is |
| | | component | id in artifact. | quarantined; |
| | | to | Artifact signature | outer envelope |
| | | second | MUST verify against | is flagged; |
| | | communication | sender_authority_{—} | failure receipt |
| | | plane. | cert_chain. | generated; state |
| | | | | remains |
| | | | | DELIVERED |
| | | | | (not |
| | | | | ADMISSION_{—} |
| | | | | PENDING). |
| ADMISSION_{—} | ADMITTED | Admission | All | Any |
| PENDING | | control | AdmissionCondition | HARD_FAIL |
| | | engine | records evaluated | condition |
| | | returns | conjunctively | returns FALSE: |
| | | PASS to | (subject to | defined failure |
| | | state | disjunction_group_{—} | enforcement |
| | | transition | id). Cryptographic | behavior |
| | | controller. | profile validated by | enforced |
| | | | cryptographic | (quarantine, no |
| | | | validation module. | key release, |
| | | | All HARD_FAIL | failure receipt |
| | | | conditions must | generated). |
| | | | return TRUE. | State remains |
| | | | | ADMISSION_{—} |
| | | | | PENDING. |
| ADMITTED | RELEASE_{—} | State | All | Any release |
| | QUALIFIED | transition | ReleaseCondition | condition fails: |
| | | controller | records evaluated. If | state remains |
| | | evaluates | biometric_step_up_{—} | ADMITTED. |
| | | release_{—} | required = TRUE, a | No key release. |
| | | conditions | valid biometric | Informational |
| | | field. | assurance token | receipt |
| | | | scoped to this | generated. |
| | | | communication_{—} | |
| | | | object_id must be | |
| | | | present. | |
| RELEASE_{—} | RELEASED | All release | Secondary | Secondary |
| QUALIFIED | | conditions | authorization event | authorization |
| | | met; | token (if required) | token missing, |
| | | secondary | validated: token | expired, or |
| | | authorization | must reference this | invalid: state |
| | | event | artifact_id, must not | remains |
| | | completed | be expired, must be | RELEASE_{—} |
| | | (if | signed by the | QUALIFIED. No |
| | | required). | authorized step-up | key release. |
| | | | authority. | Receipt |
| | | | | generated. |
| RELEASED | PARTIALLY_{—} | One or | Per-attachment | No failure - |
| | RELEASED | more | ReleaseCondition | PARTIALLY_{—} |
| | | attachment | records evaluated | RELEASED is |
| | | release | individually. Body | a valid |
| | | conditions | release conditions | intermediate |
| | | are | fully satisfied. | state, not an |
| | | satisfied | | error condition. |
| | | but not all. | | |
| RELEASED or | REEVALUATION_{—} | Post- | Qualifying event | Unauthenticated |
| PARTIALLY_{—} | PENDING | release | type must match a | or unmatched |
| RELEASED | | enforcement | RevocationRule in | event: state |
| | | module | revocation_rules | remains |
| | | detects | field. Event must be | RELEASED. |
| | | qualifying | authenticated (e.g., | Informational |
| | | post- | threat intelligence | receipt |
| | | release | update must carry | generated. No |
| | | event. | valid authority | key |
| | | | signature). | invalidation. |
| REEVALUATION_{—} | REVOKED | Post- | Re-evaluation of all | If re-evaluation |
| PENDING | | release | release conditions | determines |
| | | enforcement | and admission | conditions are |
| | | module | conditions against | still satisfied, |
| | | determines | current context. If | state transitions |
| | | prior | any HARD_FAIL | back to |
| | | release | condition now | RELEASED. |
| | | conditions | returns FALSE, | Re-evaluation |
| | | no longer | revocation is | receipt |
| | | satisfied. | mandatory. | generated. |
| RELEASED, | EXPIRED | Time- | Expiration time | Clock |
| PARTIALLY_{—} | | bound | encoded in | synchronization |
| RELEASED, or | | release | release_conditions | failure: state |
| REEVALUATION_{—} | | condition | field must be | transition |
| PENDING | | window | exceeded per state | controller uses |
| | | expires | transition controller | its own clock. |
| | | (GeneralizedTime | clock (synchronized | Conservative |
| | | comparison | via NTP or GPS- | behavior: if |
| | | by state | disciplined source). | clock |
| | | transition | | uncertainty |
| | | controller). | | exceeds 30 |
| | | | | seconds, |
| | | | | expiration is |
| | | | | treated as |
| | | | | expired. |
| REVOKED or | (terminal) | No further | N/A | N/A - |
| EXPIRED | | state | | REVOKED |
| | | transitions | | and EXPIRED |
| | | permitted. | | are terminal |
| | | | | states. Audit |
| | | | | log remains |
| | | | | available. |

### 7. Complete Message Flow Examples

The following message flow examples provide step-by-step protocol execution sequences sufficient for a person of ordinary skill in the art to implement the invention. All component interactions are described at the interface level.

### 7.1 Nominal Flow: Government Agency to Agency-Hybrid PQC, Biometric Step-Up

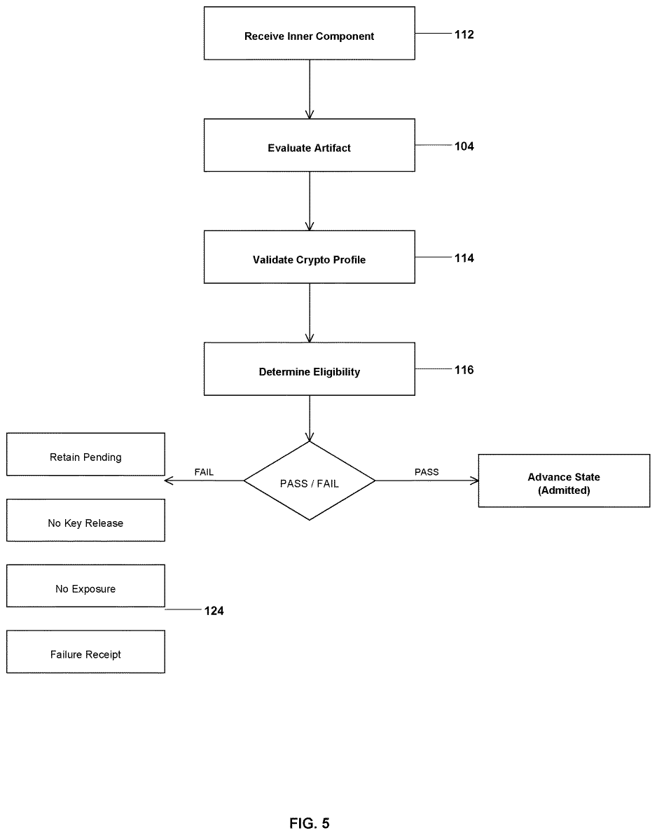

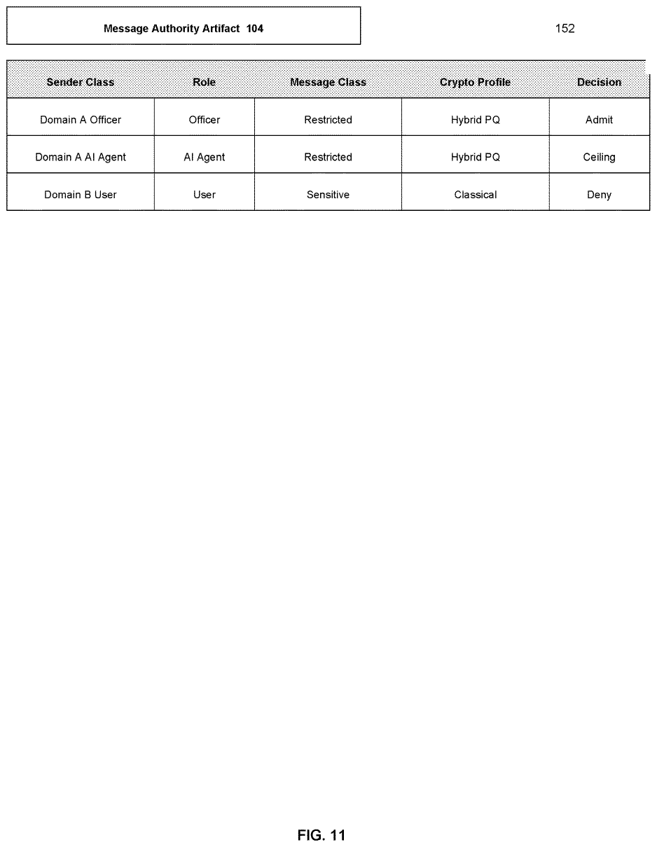

Referring to FIG. 5 and FIG. 11, This example illustrates the complete nominal protocol flow for a message class 0x0002 (OPERATIONAL) message from a Navy Command sender to an Army recipient domain using the GOV-HYBRID-PQ-1 cryptographic profile.

STEP 1 - COMPOSITION (Sender Side)

| 1.1 | Sender composes message in VEMP-aware client (Outlook plugin or native client). | |
|---|---|---|
| 1.2 | Policy and Sensitivity Engine classifies message as OPERATIONAL (0x0002). | |
| 1.3 | Artifact Generator calls HSM API: HSM.SealArtifact({ | |
| | sender_authority_id: ‘O=NavyCommand,OU=CryptoOps,C=US’, | |
| | sender_role_id: | ‘COMMANDING_OFFICER’, |
| | message_class: | 0x0002, |
| | admission_conditions: [ | |
| | { type: 0x01, value: ‘O=ArmyCommand,C=US’, failure: HARD_FAIL }, | |
| | { type: 0x02, value: ‘OPERATIONAL_RECIPIENT’, failure: HARD_FAIL }, | |
| | { type: 0x03, value: ‘GOV-HYBRID-PQ-1’, failure: HARD_FAIL } | |
| | ], | |
| | release_conditions: [{ biometric_step_up_required: TRUE, ial_minimum: 3 }], | |
| | crypto_profile_id: | ‘GOV-HYBRID-PQ-1’, |
| | lineage_control: | { authorized_participants: [‘O=NavyCommand,C=US’, |
| | ‘O=ArmyCommand,C=US’], max_ai_ceiling: 0x02 }, | |
| | revocation_rules: | [{ trigger: SENDER_COMPROMISE, action: |

REVOKE_ALL_KEYS }]
})

| | |
|---|---|
| 1.4 | HSM returns sealed artifact (2468-byte hybrid signature appended). |
| 1.5 | Client generates random 256-bit CEK via HSM DRBG. |
| 1.6 | Client encrypts message body under AES-256-GCM(CEK, IV, |

AAD=artifact_id||comm_obj_id).

| | |
|---|---|
| 1.7 | Client performs hybrid KEM: P-384-ECDH(recipient_pub_key) + |

Kyber768(recipient_kem_key).
CEK is wrapped under HKDF-SHA384(ecdh_shared || kyber_shared).

| | |
|---|---|
| 1.8 | Client assembles InnerContentComponent and OuterDeliveryComponent. |
| 1.9 | Client transmits OuterDeliveryComponent via standard SMTP |

InnerContentComponent is routed to recipient second-plane ingress via HTTPS/mTLS.
STEP 2 - FIRST PLANE DELIVERY

| | |
|---|---|
| 2.1 | Recipient MTA receives OuterDeliveryComponent. |
| 2.2 | MTA delivers outer envelope to recipient inbox (subject: ‘[VEMP-PROTECTED] |

Operational Notice’).

| | |
|---|---|
| 2.3 | Recipient sees notification: ‘A protected communication is pending. Artifact: |

<artifact_id>.’
No substantive content is visible in the inbox.
STEP 3 - SECOND PLANE INGRESS

| | |
|---|---|
| 3.1 | Recipient second-plane ingress gateway receives InnerContentComponent via |

HTTPS/mTLS.

| | |
|---|---|
| 3.2 | Ingress gateway verifies TLS client certificate of sender gateway. |
| 3.3 | Ingress gateway computes SHA-256 of encrypted_content_blob. |

```
    Verifies result matches communication_object_id in artifact.
    MATCH: proceed. MISMATCH: quarantine, failure receipt, DELIVERED state
retained.
```

| | |
|---|---|
| 3.4 | Ingress gateway verifies artifact_signature using sender_authority_cert_chain. |

VALID: advance to ADMISSION_PENDING. INVALID: quarantine, failure receipt.

| | |
|---|---|
| 3.5 | State transition controller sets state to ADMISSION_PENDING in replicated state |

store.
State record replicated to all 3 nodes before proceeding.
STEP 4 - ADMISSION EVALUATION

| | |
|---|---|
| 4.1 | Admission control engine loads artifact admission_conditions. |
| 4.2 | Condition 0x01 evaluation: query CommunicationAdmissionMatrix. |

```
    sender_authority_id ‘O=NavyCommand,OU=CryptoOps,C=US’ checked against matrix.
    RESULT: AUTHORIZED for message_class 0x0002 to recipient domain
O=ArmyCommand,C=US.
```

| | |
|---|---|
| 4.3 | Condition 0x02 evaluation: recipient role ‘OPERATIONAL_RECIPIENT’ verified |

against recipient's role-assignment record. RESULT: SATISFIED.

| | |
|---|---|
| 4.4 | Condition 0x03 evaluation: cryptographic validation module invoked. |

```
    Module checks: signing_algorithm_classical = P-384 (OID match: PASS),
    signing_algorithm_pqc = ML-DSA-65 (OID 2.16.840.1.101.3.4.3.18, RFC 9881 match:
PASS),
    hybrid_mode_required = TRUE (both present: PASS),
    hardware_root_attestation_required = TRUE (TPM quote present and valid: PASS),
    downgrade_prevention_floor = not violated (PASS).
    RESULT: CRYPTO PROFILE COMPLIANT.
```

| | |
|---|---|
| 4.5 | Admission control engine signals state transition controller: PASS. |
| 4.6 | State transition controller evaluates artifact precondition records: all SATISFIED. |
| 4.7 | State machine advanced to ADMITTED. Replicated to all 3 nodes. |
| 4.8 | Verifiable receipt generator produces ADMISSION_RECEIPT: |

{ event: ADMITTED, artifact_id, comm_obj_id, timestamp, preconditions_evaluated: 3,

preconditions_satisfied: 3, crypto_profile: ‘GOV-HYBRID-PQ-1’,
actor: ‘O=ArmyCommand,CN=AdmissionControlNode-1’ }

Receipt signed by receipt-signing key in HSM. Appended to hash-chained audit log.
STEP 5 - RELEASE QUALIFICATION

| | |
|---|---|
| 5.1 | State transition controller evaluates release conditions: |

biometric_step_up_required = TRUE, ial_minimum = 3.

| | |
|---|---|
| 5.2 | Recipient is prompted for biometric step-up (facial recognition on managed endpoint). |
| 5.3 | Biometric provider produces assurance token: |

{ token_type: BIOMETRIC_ASSURANCE, scoped_to: artifact_id,

| | |
|---|---|
| | ial_achieved: 3, issued_at: T0, expires_at: T0+900s, signature: ... } |
| 5.4 | State transition controller validates token: scope matches, IAL >= 3, not expired. |
| 5.5 | State machine advanced to RELEASE_QUALIFIED, then immediately to RELEASED |

(no secondary hold). Replicated to all 3 nodes.

| | |
|---|---|
| 5.6 | HSM-bound KMS releases CEK to authorized recipient process (in-memory only, |

```
    not persisted to disk). CEK transmission uses ephemeral P-384 ECDH key agreement
    with recipient process's ephemeral public key.
```

| | |
|---|---|
| 5.7 | Verifiable receipt generator produces RELEASE_RECEIPT. |

STEP 6 - CONTENT ACCESS

| | |
|---|---|
| 6.1 | Authorized recipient process decrypts message body using released CEK. |
| 6.2 | Recipient reads content within controlled rendering engine. |
| 6.3 | Rendering engine enforces: no clipboard copy, no print-screen, watermark applied. |
| 6.4 | Biometric assurance token expires at T0+900s. |

```
    State transition controller detects expiration.
    State machine transitions to REEVALUATION_PENDING.
    KMS invalidates CEK copy in recipient process memory.
    Re-authentication required for further access.
```

### 7.2 Failure Flow: Unauthorized Sender-Hard Fail Enforcement

| | |
|---|---|
| STEP 1 | External commercial sender transmits OuterDeliveryComponent to restricted |

enclave.

| | |
|---|---|
| STEP 2 | InnerContentComponent received at second-plane ingress gateway. |
| STEP 3 | Ingress gateway validates artifact signature: VALID (artifact is well-formed). |

State advanced to ADMISSION_PENDING.

| | |
|---|---|
| STEP 4 | Admission control engine evaluates condition 0x01: |

```
  sender_authority_id ‘O=ExternalCorp,C=US’ queried against
CommunicationAdmissionMatrix.
  RESULT: NOT FOUND - no admission record for this sender and message_class
combination.
  Condition type 0x01 with failure_disposition HARD_FAIL returns FALSE.
```

| | |
|---|---|
| STEP 5 | Admission control engine immediately signals state transition controller: FAIL. |

Evaluation of remaining conditions 0x02 and 0x03 is SKIPPED (hard fail short-circuit).

| | |
|---|---|
| STEP 6 | State transition controller enforces defined failure enforcement behavior: |
| (i) | State machine remains in ADMISSION_PENDING. No state advancement. |
| (ii) | HSM-bound KMS: no decryption key release command issued. |
| (iii) | encrypted_content_blob: not forwarded to any recipient system or process. |
| (iv) | Outer delivery component: notification email retained in first communication |
| | plane (recipient sees: ‘A protected message was received but could not be |
| | admitted. Contact your security administrator.’). |
| (v) | Verifiable receipt generator produces FAILURE_RECEIPT: |
| | { event: ADMISSION_FAILED, artifact_id, comm_obj_id, timestamp, |
| | failure_reason: ‘SENDER_ORG_NOT_AUTHORIZED’, |
| | evaluated_sender: ‘O=ExternalCorp,C=US’, |
| | evaluated_message_class: 0x0001, |
| | admission_matrix_lookup: ‘NO_RECORD’ } |
| | Receipt signed by HSM receipt-signing key. Appended to audit log. |
| STEP 7 | Security administrator is alerted via out-of-band channel (SIEM integration). |

No content exposure has occurred. Bypass is detectable through audit log inspection.

### 7.3 AI-Agent Lineage Violation Flow

```
CONTEXT: Original communication object (comm_obj_id=A) admitted and released to
recipient.
  Recipient delegates handling to an AI agent (CLASS_B,
max_authority_ceiling=0x02=REPLY_WITHIN_THREAD).
  AI agent generates reply asserting message_class 0x0005 (EXECUTIVE).
STEP 1 AI agent constructs derived communication object:
  parent_communication_id = comm_obj_id=A
  message_class = 0x0005 (EXECUTIVE)
  sender_role_id = ‘AI_AGENT_CLASS_B’
  lineage_id = (inherited from parent lineage_control)
STEP 2 Lineage tracking module intercepts derived communication before forwarding
  to admission control engine.
STEP 3 Lineage tracking module retrieves lineage continuity record for lineage_id.
  Record states: max_authority_ceiling_ai_agent = 0x02 (REPLY_WITHIN_THREAD).
  Permitted message classes for AI agent: [0x0001, 0x0002].
STEP 4 Lineage tracking module evaluates derived communication:
  message_class 0x0005 NOT IN permitted_message_classes [0x0001, 0x0002].
  LINEAGE VIOLATION DETECTED: authority scope exceeds maximum-authority
ceiling.
STEP 5 Lineage tracking module denies forwarding to admission control engine.
  State machine advancement denied.
STEP 6 Verifiable receipt generator produces LINEAGE_VIOLATION_RECEIPT:
  { event: LINEAGE_VIOLATION, parent_comm_obj_id: A, derived_artifact_id: ...,
    asserted_message_class: 0x0005, permitted_classes: [0x0001, 0x0002],
    max_authority_ceiling: 0x02, agent_role: ‘AI_AGENT_CLASS_B’, timestamp: ... }
  Receipt appended to audit log.
STEP 7 Human operator notified of unauthorized AI authority escalation attempt.
  Derived communication is quarantined.
```

### 7.4 Post-Release Revocation Flow-HSM-Bound Key Invalidation

CONTEXT: Communication object in RELEASED state. Recipient has active content access.

Threat intelligence system detects sender compromise at time T_compromise.

STEP 1 Threat intelligence service publishes SENDER_COMPROMISE_INDICATOR:
{ indicator_type: SENDER_COMPROMISE, affected_authority_id:
‘O=NavyCommand,C=US’,

effective_from: T_compromise, severity: CRITICAL,
indicator_signature: <signed by TI authority cert> }

```
STEP 2 Post-release enforcement module receives indicator at time T_detect.
    Module validates indicator_signature against TI authority cert in TrustAnchorStore.
    VALID: proceed. INVALID: ignore and log unauthenticated indicator.
STEP 3 Post-release enforcement module queries state management store for all
    communication objects with:
```

| | |
|---|---|
| - | sender_authority_id matching ‘O=NavyCommand,C=US’ |
| - | current_state IN [RELEASED, PARTIALLY_RELEASED, |

REEVALUATION_PENDING]

| | |
|---|---|
| - | artifact revocation_rules containing trigger=SENDER_COMPROMISE |

STEP 4 For each matching communication object (e.g. comm_obj_id=A, B, C):

| | |
|---|---|
| 4.1 | Post-release enforcement module signals state transition controller: |

INITIATE_POST_RELEASE_CONTROL(comm_obj_id,
reason-SENDER_COMPROMISE)

| | |
|---|---|
| 4.2 | State transition controller validates: RevocationRule |

trigger=SENDER_COMPROMISE
present in artifact and action=REVOKE_ALL_KEYS confirmed.

| | |
|---|---|
| 4.3 | State machine rolled back: RELEASED -> REEVALUATION_PENDING. |

Propagated to all 3 nodes in replicated state store.

| | |
|---|---|
| 4.4 | State transition controller issues KEY_INVALIDATION command to HSM-bound |

KMS.

| | |
|---|---|
| 4.5 | HSM-bound KMS executes key invalidation WITHIN hardware boundary: |

```
    CEK zeroized in HSM secure memory. All key handles invalidated.
    Invalidation does NOT require recipient endpoint cooperation.
```

| | |
|---|---|
| 4.6 | State machine advanced: REEVALUATION_PENDING -> REVOKED. |

Propagated to all 3 nodes.

| | |
|---|---|
| 4.7 | Verifiable receipt generator produces REVOCATION_RECEIPT: |

{ event: REVOKED, comm_obj_id, artifact_id, trigger: SENDER_COMPROMISE,

t_compromise: T_compromise, t_detect: T_detect, t_invalidated: T_invalidated,
enforcement_latency_ms: (T_invalidated − T_detect),
nodes_confirmed: 3, hsm_attestation: <HSM attestation quote> }

```
    Receipt appended to audit log.
STEP 5 Revocation enforcement latency = T_invalidated − T_detect.
    In preferred embodiment with 3-node sovereign deployment: target < 5000ms.
    Latency is bounded by replicated state store propagation time,
    NOT by recipient endpoint connectivity or cooperation.
STEP 6 Recipient endpoint: next decryption attempt returns KMS error.
    Message body becomes inaccessible. Rendering engine displays:
    ‘This communication has been revoked. Contact your security administrator.’
STEP 7 Security administrator may inspect audit log to reconstruct complete
    access history from DELIVERED through REVOKED for each affected object.
```

### 8. Lineage Continuity Record-Concrete Structure and Examples

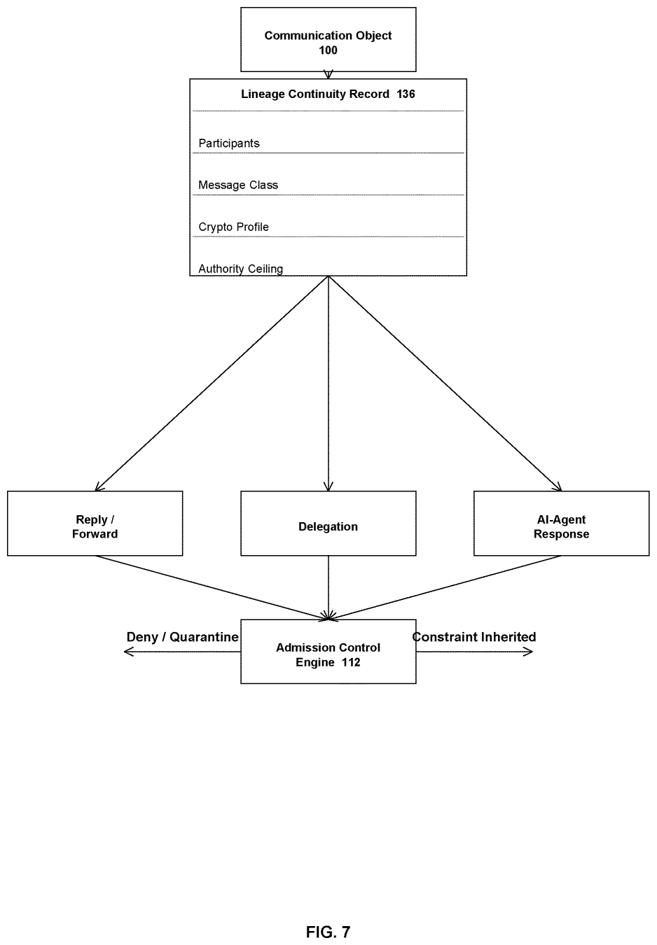

Referring to FIG. 7, The lineage tracking module generates a cryptographic lineage continuity record upon admission of the root communication object. This record is stored in the state management store and is evaluated by the lineage tracking module for each derived communication. The record has the following concrete structure:

LineageContinuityRecord {

| | |
|---|---|
| lineage_id: | UUID v4 (generated at root admission time) |

root_communication_object_id: UUID v4 (comm_obj_id of root)

| | |
|---|---|
| root_artifact_id: | UUID v4 (artifact_id of root) |
| lineage_created_at: | GeneralizedTime |
| lineage_authority: | X.509 Certificate of lineage authority |

```
  authorized_participant_set: [
    { participant_dn: ‘O=NavyCommand,OU=CryptoOps,C=US’, role: ‘ORIGINATOR’ },
    { participant_dn: ‘O=ArmyCommand,OU=Operations,C=US’, role: ‘RECIPIENT’ }
  ],
  permitted_message_classes: [0x0001, 0x0002],
  max_authority_ceiling_ai: 0x02, // REPLY_WITHIN_THREAD
```

| | |
|---|---|
| crypto_profile_floor: | ‘GOV-HYBRID-PQ-1’, |
| lineage_depth_limit: | 5, |

```
  derivation_chain: [
    {
```

| | |
|---|---|
| depth: | 0, |

communication_object_id: ‘ROOT-COMM-OBJ-UUID’,

| | |
|---|---|
| artifact_id: | ‘ROOT-ARTIFACT-UUID’, |
| derived_by: | ‘HUMAN_ORIGINATOR’, |
| derived_at: | T0, |
| derivation_type: | ‘ORIGINAL’ |

```
    }
    // Subsequent reply adds depth=1 entry here when admitted.
  ],
  lineage_record_signature: <ECDSA P-384 + ML-DSA-65 (RFC 9881) over all above
fields,
        signed by lineage_authority key at record creation>
}
```

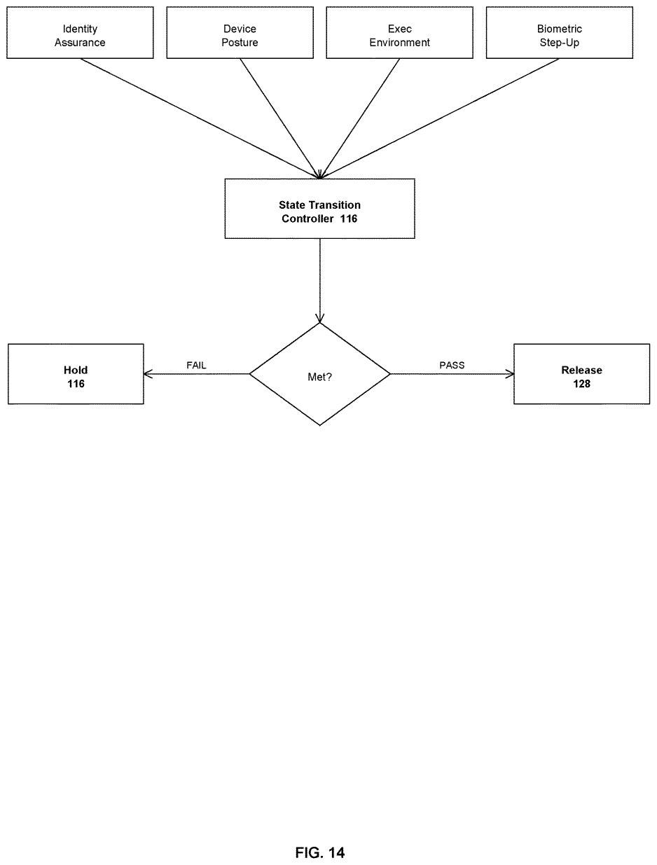

Referring to FIG. 14, When a derived communication (reply, forward, AI-agent response) is received, the lineage tracking module performs the following evaluation steps before forwarding to the admission control engine:
Step 1: Retrieve the lineage continuity record by lineage_id from the state management store. If no record is found, treat as a novel root communication and initiate standard admission.
Step 2: Verify lineage_record_signature against lineage_authority certificate. A signature failure causes the derived communication to be quarantined.
Step 3: Evaluate the derived communication's sender against authorized_participant_set. If the sender DN is not present and the derivation type would introduce a new participant, generate a LINEAGE_PARTICIPANT_VIOLATION receipt and deny forwarding.
Step 4: Evaluate the derived communication's message_class against permitted_message_classes. A mismatch generates a LINEAGE_CLASS_VIOLATION receipt.
Step 5: If the sender_role_id indicates an AI agent, evaluate the asserted authority against max_authority_ceiling_ai. An exceedance generates a LINEAGE_AUTHORITY_VIOLATION receipt.
Step 6: Evaluate the derived communication's crypto_profile_id against crypto_profile_floor. A weaker profile generates a LINEAGE_PROFILE_VIOLATION receipt.
Step 7: Evaluate the derivation depth (depth of this communication in the derivation_chain) against lineage_depth_limit. A depth exceedance generates a LINEAGE_DEPTH_VIOLATION receipt.
Step 8: If all evaluations pass, append a new entry to derivation_chain, re-sign the updated lineage continuity record under the lineage authority key, and forward the derived communication to the admission control engine.

### 9. Failure Enforcement Behavior—Implementation Requirements

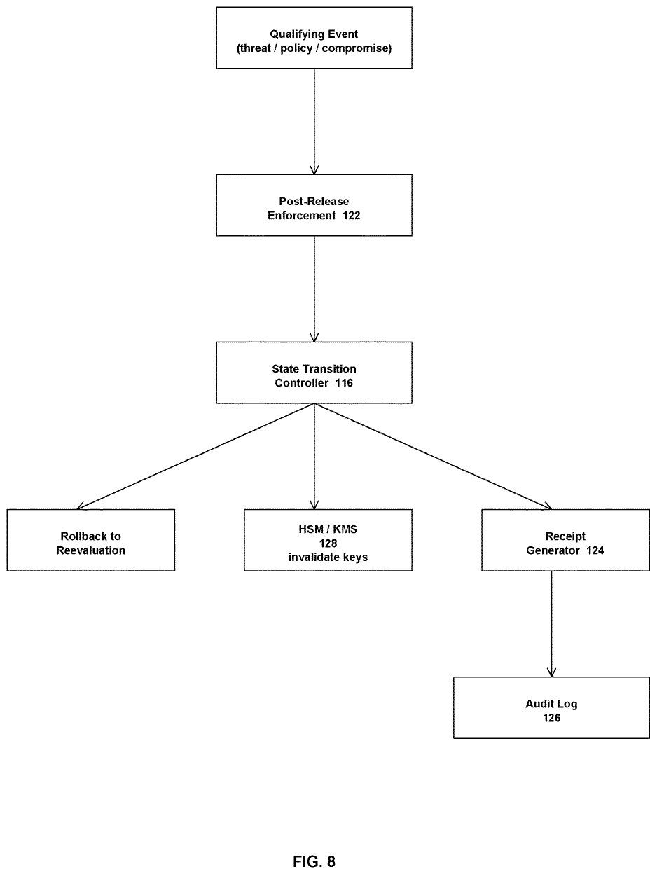

Referring to FIG. 8, Upon receipt of a fail result from the admission control engine, the state transition controller enforces the following defined failure enforcement behavior as a mandatory protocol consequence, not a discretionary option: (i) the communication object is retained in the admission-pending state and is not advanced to any more permissive state; (ii) no decryption keys are released by the hardware-security-module-bound key management service; (iii) the encrypted content is not exposed to any recipient system, process, or user; (iv) the outer delivery component may be retained in the first communication plane for routing or notification purposes, but the inner content component is not forwarded to any recipient-accessible environment; and (v) the verifiable receipt generator produces a tamper-evident failure receipt.

A conformant implementation must satisfy all five consequences simultaneously. A partial implementation that enforces four of the five consequences is not conformant and is detectable through audit log inspection because the missing consequence will produce no corresponding audit record. In particular: a conformant audit log must contain a FAILURE RECEIPT for every admission failure event. Absence of a FAILURE RECEIPT in the audit log for a communication object that is in ADMISSION PENDING state and has not transitioned to ADMITTED is evidence of non-conformant implementation.

### 10. Verifiable Receipts and Tamper-Evident Audit Log

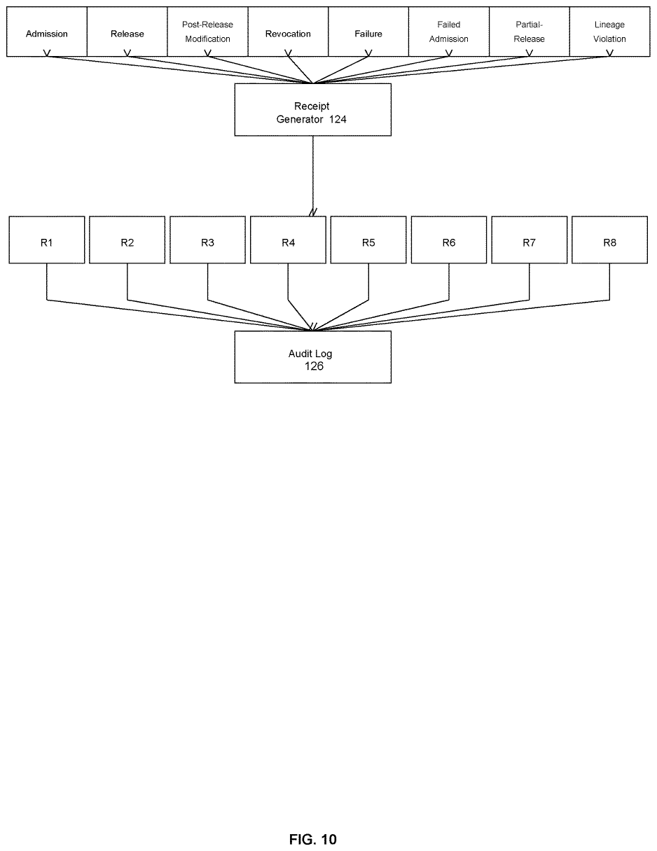

Referring to FIG. 10, The verifiable receipt generator produces cryptographically signed, tamper-evident verifiable receipts for each governed event. Each receipt is digitally signed by the verifiable receipt generator using a dedicated receipt-signing key maintained in the same hardware security module boundary as the artifact-sealing key, and is appended to a tamper-evident audit log whose integrity is verifiable through a cryptographic hash chain.

The hash chain is implemented as follows: each receipt R_n is appended to the log with a chain_hash field computed as SHA-384(R_{n−1}.chain_hash∥SHA-384 (R_n.canonical_bytes)). The root entry R_0 contains a chain_hash of SHA-384 (0x00*48). Any modification or deletion of a receipt record at position n is detectable because it invalidates chain_hash for all subsequent records.

The audit log is replicated across a minimum of three nodes within the sovereign deployment boundary. A compliance auditor may verify the audit log by: (i) retrieving the complete log from any node; (ii) verifying each receipt's digital signature against the receipt-signing key's public certificate; (iii) verifying the hash chain from R_0 to the most recent entry; and (iv) cross-referencing receipt counts across nodes. Any discrepancy indicates log tampering.

### 11. State Machine Enforcement Across Distributed Systems

In distributed embodiments, the state transition controller maintains a consistent state representation across a plurality of distributed computing systems through a replicated state management store, such that state transitions enforced on one node are reflected across all participating nodes. No distributed node can unilaterally advance the state machine to a more permissive state; advancement requires coordination with the state transition controller and affirmative validation of artifact-encoded state-transition preconditions. The replicated state management store implements a consensus protocol (Raft or Paxos in the preferred embodiment) with a minimum quorum of two of three nodes required for any state-advancing write. State-advancing writes are: any transition to ADMITTED, RELEASE QUALIFIED, or RELEASED. State-demoting writes (REEVALUATION PENDING, REVOKED, EXPIRED) require only a single-node write to take immediate effect, ensuring that revocation is not blocked by node unavailability.

### 12. Cryptographic Profile as State-Machine Gate

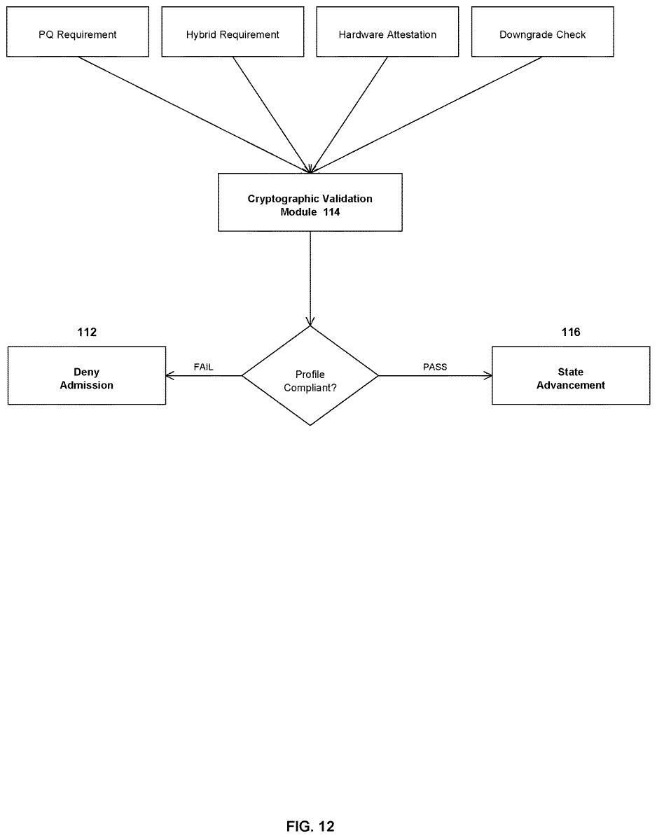

Referring to FIG. 12, Cryptographic profile validation is implemented as a state-machine-gated admission prerequisite such that the communication object cannot advance from the admission-pending state to the admitted state unless the cryptographic profile fully satisfies the approved cryptographic policy. Algorithmic signature validity alone is insufficient; cryptographic profile compliance is an independent and additional state-transition precondition stored in association with the artifact and validated by the cryptographic validation module. In the preferred embodiment the approved cryptographic policy requires ML-DSA-65 (NIST FIPS 204, RFC 9881; formerly CRYSTALS-Dilithium3) as the post-quantum signing component and CRYSTALS-Kyber768 (NIST FIPS 203, ML-KEM-768) as the post-quantum key encapsulation component, combined with ECDSA P-384 and ECDH P-384 classical components.

The foregoing named algorithms, object identifiers, parameter sets, and standards references are illustrative of preferred embodiments and are provided to demonstrate concrete enablement of the disclosed architecture. In other embodiments, the cryptographic profile may specify alternative classical algorithms, alternative post-quantum algorithms, alternative hybrid combinations, alternative attestation requirements, alternative key-provenance requirements, or algorithm-agility policies defined by registry, policy store, standards profile, domain-specific trust descriptor, or dynamically updateable cryptographic governance record.

In some embodiments, the cryptographic profile requires one or more signature algorithms, one or more key-establishment or key-encapsulation mechanisms, one or more encryption algorithms, one or more attestation mechanisms, and one or more downgrade-prevention constraints, without requiring any specific named algorithm so long as the required assurance properties are satisfied. In other embodiments, the cryptographic profile may be defined in terms of functional classes, including classical signature, post-quantum signature, classical key agreement, post-quantum key encapsulation, hardware-root attestation, enclave attestation, secure key provenance, sovereign trust anchor validation, or equivalent assurance categories.

Thus, the present disclosure is not limited to ECDSA, ECDH, ML-DSA, ML-KEM, Kyber, Dilithium, specific OIDs, or specific FIPS, RFC, or other standards designations unless expressly recited in a claim, and any cryptographic primitive or cryptographic suite capable of participating in the disclosed admission-before-decryption, state-machine-governed release, artifact-bound transition enforcement, lineage-bound constraint propagation, and post-release control architecture may be used.

### 13. Best Mode of Carrying Out the Invention

Pursuant to 35 U.S.C. § 112 (a), the best mode contemplated by the inventor for carrying out the claimed subject matter, as of the filing date of this application, is as follows.

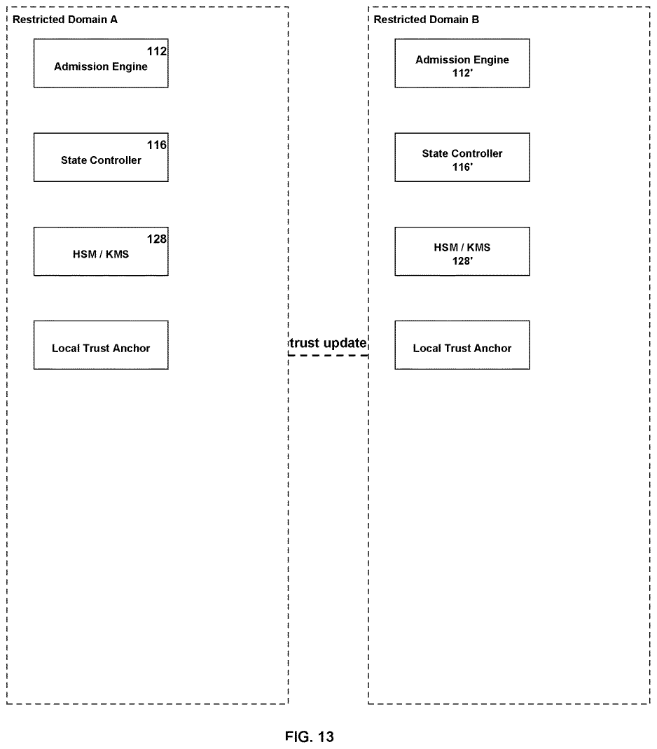

Referring to FIG. 13, The preferred embodiment comprises a sovereign on-premises deployment in which the second communication plane, the admission control engine, the cryptographic validation module, the state transition controller, the lineage tracking module, the post-release enforcement module, the verifiable receipt generator, and the hardware-security-module-bound key management service are hosted entirely within infrastructure under the physical and logical control of a single restricted recipient organization, with no dependency on external cloud services, external key management endpoints, or externally hosted authority resolution services during normal admission, release, or post-release operations.

In the preferred embodiment, message authority artifacts are generated and sealed within a FIPS 140-2 Level 3 or higher certified hardware security module using a signing key that is non-exportable and whose generation is attested by a hardware-root-of-trust anchor. The preferred cryptographic profile requires a hybrid classical-plus-post-quantum configuration comprising ECDSA P-384 (classical signing) and ML-DSA-65 (post-quantum signing, NIST FIPS 204, RFC 9881; OID 2.16.840.1.101.3.4.3.18), combined with P-384 ECDH (classical key agreement) and CRYSTALS-Kyber768/ML-KEM-768 (post-quantum KEM, NIST FIPS 203), using HKDF-SHA384 as the hybrid key derivation function. State-transition precondition records are stored in association with each message authority artifact in a tamper-resistant state management store replicated across a minimum of three nodes within the sovereign deployment boundary, using the Raft consensus protocol with leader election timeout of 150-300 ms.

In the preferred embodiment, recipient eligibility determination evaluates recipient device posture, identity assurance level, and execution environment integrity as admission preconditions for advancement from the admission-pending state to the admitted state. In the preferred embodiment, for message classes designated as requiring elevated assurance (message_class>=0x0003), a biometric step-up verification event is additionally required as a release precondition stored in the release_conditions field of the message authority artifact, governing advancement from the admitted state to the released state and producing a time-limited, message-scoped biometric assurance token valid for no more than fifteen minutes from issuance. The biometric assurance token includes a cryptographic scope binding field containing the SHA-256 hash of the artifact id to which it applies, preventing token reuse across communication objects. The verifiable receipt generator signs each verifiable receipt using a dedicated receipt-signing key maintained within the same hardware security module boundary as the artifact-sealing key, using ECDSA P-384 for the receipt signature. Receipts are appended to a hash-chained audit log replicated across a minimum of three nodes. Post-release revocation is enforced through direct key invalidation by the hardware-security-module-bound key management service within a revocation enforcement latency target of less than five seconds from the triggering event to invalidation completion across all nodes within the sovereign deployment boundary. This latency target is achievable on commodity hardware with gigabit LAN interconnect and Raft propagation; the target is not dependent on internet connectivity or external service availability.

### 14. Federated Multi-Domain Admission Control

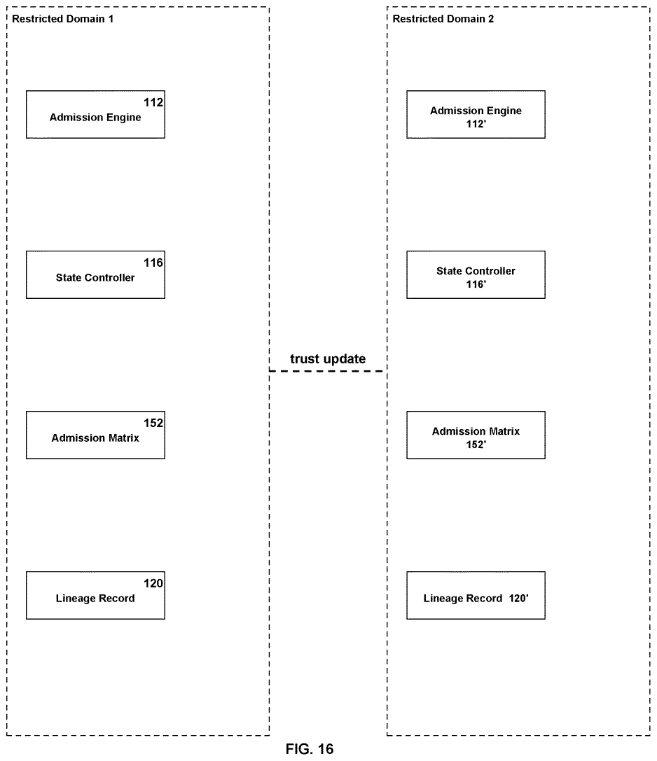

Referring to FIG. 16, In some embodiments, the architecture supports a federated multi-domain configuration in which a plurality of independent restricted recipient domains, each maintaining its own sovereign communication admission matrix, participate in a controlled cross-domain communication governance framework. Each domain in the federation independently maintains its own admission control engine, state transition controller, and cryptographic validation module, and each domain independently evaluates admission conditions for communications received from other federation participants. No domain is required to accept communications that have been admitted by another domain without performing its own independent admission evaluation.

In the federated multi-domain embodiment, cross-domain communication governance is established through mutual trust descriptor exchange between domain admission authorities. A trust descriptor published by a first domain encodes the set of message classes the first domain is authorized to send to a second domain, the cryptographic profiles under which such communications will be presented, the sender role classes authorized to originate cross-domain communications, and the maximum-authority ceiling applicable to AI-agent-originated cross-domain communications. The second domain's admission control engine evaluates incoming communications from the first domain against the trust descriptor applicable to that domain pair, independently of any admission decision made by the first domain.

In some embodiments, trust descriptors are signed by a federation authority and distributed to participating domains through authenticated trust-update packages verifiable using locally held root trust anchors, enabling federated admission governance in sovereign and air-gapped deployment topologies without requiring live cross-domain network queries during admission evaluation. This enables offline admission evaluation: a domain that is air-gap isolated can still evaluate admission for communications from federation partners using locally cached trust descriptors, so long as the trust descriptor has not exceeded its validity period.

### 15. Example Operational Scenarios

Example 1: Artifact-Bound State Transition Validation. A communication object is received in the first communication plane. The admission control engine evaluates the authorization conditions encoded in the message authority artifact and validates the cryptographic profile. The state transition controller validates the state-transition preconditions stored in association with the artifact before advancing the state machine from admission-pending to admitted. The preconditions are satisfied, advancement occurs, and the verifiable receipt generator produces a tamper-evident admission receipt. Refer to Section 7.1 for the complete step-by-step execution of this scenario.

Example 2: Defined Failure Enforcement Behavior. An admission evaluation fails because the sender organization does not satisfy the authorization conditions encoded in the artifact. Refer to Section 7.2 for the complete execution of this scenario, including the five-element failure enforcement behavior and the resulting failure receipt structure.

Example 3: Verifiable Receipt Audit Trail. A compliance auditor requires evidence that access to a governed communication object was granted only under defined conditions. The auditor retrieves the verifiable receipts from the tamper-evident audit log, verifies the digital signatures on each receipt, and reconstructs the complete governance history of the communication object from delivery through release. The hash chain provides mathematical proof that no receipt has been modified or deleted.

Example 4: Cryptographic Profile Gate Prevents Advancement Despite Valid Signature. A communication object presents an algorithmically valid ECDSA P-384 signature but lacks an ML-DSA-65 (OID 2.16.840.1.101.3.4.3.18) post-quantum signing component. The approved cryptographic policy requires hybrid_mode_required=TRUE. The cryptographic validation module returns a FAIL result for the CryptoProfileSpec evaluation. The state transition controller maintains the communication object in ADMISSION PENDING. The failure receipt records:

failure_reason=‘CRYPTO_PROFILE_HYBRID_INCOMPLETE’,
missing_component=‘PQC_SIGNING’.

Example 5: AI-Agent Lineage Violation with Audit Evidence. Refer to Section 7.3 for the complete execution of this scenario.

Example 6: Post-Release Rollback with Bounded Revocation Latency. Refer to Section 7.4 for the complete execution of this scenario, including the timing model and HSM invalidation sequence.

Example 7: Federated Multi-Domain Cross-Domain Admission. A communication originates from a sender in a first restricted domain and is addressed to a recipient in a second restricted domain. The second domain's admission control engine performs an independent admission evaluation against the second domain's communication admission matrix, evaluating the domain-pair trust descriptor published by the first domain. The second domain's state machine advances independently. A fresh lineage continuity record is generated binding the cross-domain communication to the original lineage record from the first domain.

Example 8: Best Mode Sovereign Deployment-Biometric Step-Up with HSM Revocation. A communication object is received in the sovereign on-premises deployment. The admission control engine evaluates the message authority artifact sealed within the FIPS 140-2 Level 3 HSM, validating the hybrid ECDSA P-384 and ML-DSA-65 (OID 2.16.840.1.101.3.4.3.18, RFC 9881) cryptographic profile. Admission succeeds and the state machine advances to the admitted state. The release precondition record requires a biometric step-up event. The recipient completes facial recognition on a managed endpoint, producing a message-scoped biometric assurance token valid for fifteen minutes and scoped to the specific artifact_id. The state transition controller advances to the released state and the HSM-bound key management service releases the CEK. Twenty minutes later, a threat intelligence update indicates recipient device compromise. The post-release enforcement module signals state machine rollback; the HSM-bound key management service invalidates the CEK across all three sovereign deployment nodes within the five-second revocation enforcement latency target. The biometric assurance token has independently expired. The verifiable receipt generator produces a revocation receipt signed by the HSM-bound receipt-signing key.

### 16. Technical Distinctions from Prior Art—Consolidated Prosecution Record

The following technical distinctions are set forth for prosecution history purposes and are incorporated by reference into any response to Office Actions in this application.

The disclosed system is not a secure email system. Characterizing the present disclosure as a form of encrypted email or secure messaging—including S/MIME, OpenPGP, or Microsoft Purview encryption—would materially misrepresent its architectural scope. Those systems encrypt content in transit and at rest; encryption is incidental to the present disclosure. The core mechanisms of the present disclosure operate before any decryption occurs, enforcing whether a communication object is ever admitted into the controlled communication plane at all. No encrypted email or secure messaging system implements a formally defined communication state machine, an artifact-bound pre-decryption admission evaluation, HSM-governed key management conditioned on state machine advancement, or post-delivery decryption-key revocation with bounded enforcement latency independent of the recipient endpoint.

The disclosed system is not a secure email gateway or mail transfer agent filter. Secure email gateways—including products implementing domain authentication, anti-spam, and anti-malware filtering at the mail transfer boundary—make a binary deliver-or-block decision based on envelope-layer analysis conducted before delivery. A gateway decides whether a message arrives; the present disclosure governs whether an already-delivered message is ever admitted into a controlled communication plane. These operations occur at different points in the communication lifecycle, use different mechanisms, and address different threat classes. Gateway filtering cannot address threats originating from legitimately authenticated sender domains that have been compromised; the present disclosure's CommunicationAdmissionMatrix evaluates sender authority chains independently of transport-layer authentication results.

The disclosed system is not a zero-trust network access system. Zero-trust access products govern identity-to-resource authorization: which users on which devices may access which network resources. The disclosed system governs communication-object-to-recipient-plane admission: whether a specific communication object, from a specific sender authority chain, under a specific cryptographic profile, may be admitted to a controlled communication plane and released to a recipient under verified conditions. The conceptual principle—never trust, always verify—is similar, but the subject, the mechanism, the data model, and the lifecycle scope are architecturally distinct. In ZTA systems, policy resides in the policy engine external to the resource being accessed. In the present disclosure, governance is bound to the communication object itself through the message authority artifact, which travels with the communication object, cannot be separated from the encrypted content without breaking integrity verification, and is evaluated at every state transition by the state transition controller.

The disclosed system is not an information rights management or data loss prevention platform. IRM and DLP platforms apply controls to content after the communication has been accepted into the recipient environment. The admitted communication is already inside the recipient perimeter; IRM then restricts subsequent operations such as printing, copying, or forwarding. The present disclosure's admission evaluation occurs before any content exposure to the recipient environment—the encrypted content never leaves the second communication plane until the state machine's artifact-evaluated preconditions are satisfied. IRM systems have no mechanism to prevent a recipient from accessing content that has already been decrypted. The present disclosure prevents decryption unless and until the state machine advances to the released state following affirmative precondition evaluation. Furthermore, IRM systems do not generate protocol-level tamper-evident verifiable receipts, do not provide HSM-governed key revocation independent of endpoint cooperation, and do not implement lineage-bound constraint propagation for derived communications.

The disclosed system is not limited to transport encryption. Transport-layer security systems protect the communication channel between nodes during transit but have no involvement with the communication object after delivery. TLS provides no concept of the communication object as a governed entity with a lifecycle, no state machine, no artifact-based admission control, and no post-delivery mechanisms of any kind.

The technical distinctions of the present disclosure do not depend on use of any single named cryptographic algorithm, standards profile, serialization format, or attestation mechanism. Rather, the distinctions reside in the architectural coordination of message-governing control data, pre-decryption admission evaluation, state-transition-controlled release, release-state-gated key access, lineage-bound derived-communication enforcement, tamper-evident governance receipts, and post-release control operations. Accordingly, substitution of one cryptographic primitive, control-object format, or attestation mechanism for another does not avoid the disclosed architectural distinctions where the substituted implementation preserves the same communication-governance relationships.

The novelty of the disclosed architecture resides in the specific, coordinated combination of: a formally defined communication state machine with artifact-stored state-transition precondition records validated by the state transition controller for each transition, creating an inseparable artifact-state-machine-transition-logic enforcement mechanism; a mandatory admission evaluation performed without decryption with defined failure enforcement behavior preventing any content exposure on admission failure; a verifiable receipt generator producing cryptographically signed, tamper-evident receipts for all governance events providing non-repudiable audit evidence; cryptographic profile compliance as a state-machine-gated admission prerequisite enforcing hybrid post-quantum requirements; lineage-bound constraint propagation across AI-agent and machine-originated communications with authority ceiling enforcement; federated multi-domain admission control with sovereign trust descriptor governance enabling air-gapped deployment; and post-release state machine rollback with bounded hardware-security-module-governed revocation enforcement latency independent of endpoint behavior. No prior art system, and no straightforward combination of prior art systems, implements this combination.

The disclosed system is not a portal-based message access control system and is not rendered obvious by Microsoft Purview Advanced Message Encryption or functionally similar encrypted email portal products. Such products condition access to encrypted email content on recipient authentication at a web portal; revocation is implemented by denying portal login, which prevents the recipient from retrieving or re-viewing content through the portal interface. These systems do not implement a message authority artifact, a formally defined communication state machine, a pre-decryption admission evaluation operating on content already in a second communication plane, or an HSM-bound key management service that invalidates decryption keys within a hardware boundary independent of recipient endpoint behavior. Critically, portal-based revocation fails when the recipient has downloaded or cached the content outside the portal, when the recipient is operating in an environment not connected to the portal, or when the portal itself is unreachable. The present disclosure's revocation mechanism operates through the hardware-security-module-bound key management service, which invalidates key material within the hardware boundary regardless of whether the recipient endpoint cooperates, regardless of whether cached copies exist, and regardless of portal availability. The architectural distinction is not temporal but structural: portal-based access denial is a network-layer authentication gate; the present disclosure's revocation is a hardware-cryptographic key destruction event.

The disclosed system is not a supply chain transparency service and is not rendered obvious by the IETF Supply Chain Integrity, Transparency, and Trust (SCITT) architecture (IETF Working Group draft-ietf-scitt-architecture) or related receipt-issuance frameworks including IETF COSE receipts and Merkle tree proof structures. SCITT provides a transparency architecture for supply chain artifact registration in which an issuer submits a signed statement to a transparency service and receives a receipt confirming registration on a ledger. SCITT receipts are signed by the transparency service and attest to ledger inclusion of the issuer's signed statement. The present disclosure's verifiable receipts are fundamentally distinct in three respects: first, they are produced by a third-party enforcement component—the verifiable receipt generator using keys held in the hardware-security-module-bound key management service—that is independent of both the sender and recipient, whereas SCITT receipts are produced by the issuer or transparency service at the issuer's request; second, they are typed to specific communication governance events—admission, release, post-release modification, revocation, and failure—and are bound to a specific communication object's state machine record, whereas SCITT receipts attest to artifact registration without reference to an associated state machine; and third, they are signed using post-quantum algorithms (ML-DSA-65, NIST FIPS 204, RFC 9881) providing quantum-resilient audit evidence, whereas no SCITT implementation is required to use post-quantum signing algorithms. The combination of HSM third-party independence, governance-event typing, state-machine binding, and post-quantum signing has no analog in any prior art receipt or audit log system.

The disclosed system is not an immutable messaging platform and is not rendered obvious by Walacor or functionally similar systems that treat enterprise messages as immutable, encrypted data assets with cryptographically protected delivery records. Such systems provide encrypted message storage, access controls based on cryptographic sharing permissions, and immutability guarantees for stored messages. They do not implement a formally defined communication state machine with artifact-stored state-transition precondition records, a pre-decryption admission evaluation separating delivery from access, HSM-governed key release conditioned on state machine advancement, post-release revocation through hardware-boundary key invalidation independent of endpoint cooperation, or lineage-bound constraint propagation for AI-agent-originated derived communications. The concept of treating a message as a cryptographic artifact is a general principle; the specific coordinated combination of mechanisms disclosed herein is not present in, or rendered obvious by, any immutable messaging platform.

The verifiable receipts produced by the present disclosure are specifically structured to satisfy the non-repudiable audit evidence requirements of regulatory frameworks including Securities and Exchange Commission Rule 17a-4(f) (requiring tamper-evident, non-rewritable electronic records of securities-related communications), Financial Industry Regulatory Authority Rule 4511 (requiring retention of records of business-related communications), Health Insurance Portability and Accountability Act Security Rule 45 C.F.R. § 164.312 (b) (requiring audit controls producing records of activity in information systems containing or using electronic protected health information), and European Union AI Act Article 13 (requiring transparency and traceability records for AI systems used in regulated contexts). The receipt structure of the present disclosure satisfies these requirements because each receipt is: signed by a signing key held within a FIPS 140-2 Level 3 or higher certified hardware security module, establishing hardware-attested authenticity; appended to a hash-chained audit log, establishing mathematical tamper-evidence such that modification of any record invalidates all subsequent records; replicated across a minimum of three nodes within the enforcement infrastructure, establishing multi-copy preservation; and typed to a specific governance event class with a defined field schema, establishing semantic specificity sufficient for regulatory event reconstruction.

The five governance event types for which the verifiable receipt generator produces receipts correspond directly to the five audit categories that regulatory investigators require when reviewing access governance for sensitive communications: the admission receipt establishes that a specific party's communication was evaluated and admitted under defined conditions at a specific time, satisfying the “who accessed what and when” requirement; the release receipt establishes that decryption keys were released to a specific authorized recipient process following biometric or other secondary authorization, satisfying the “under what conditions was content accessed” requirement; the post-release modification receipt establishes that access conditions were altered after initial release, satisfying the “was access ever modified” requirement; the revocation receipt establishes that access was terminated through HSM key invalidation at a specific time following a specific triggering event, with enforcement latency measured in milliseconds, satisfying the “was access terminated and when” requirement; and the failure receipt establishes that an unauthorized access attempt was detected and blocked before any content exposure, satisfying the “were unauthorized access attempts detected and evidenced” requirement. No prior art communication system generates receipts covering all five event categories as a mandatory protocol function.

Because the receipt-signing key is maintained within the hardware-security-module-bound key management service, and because neither the sender nor the recipient of a communication object controls or has access to that key, the verifiable receipts constitute third-party-signed non-repudiable evidence: the sender cannot forge a receipt showing admission occurred when it did not; the recipient cannot forge a receipt showing admission was denied when it was not; and neither party can deny the authenticity of a receipt bearing the hardware security module's signature. This structural independence of the receipt-generating authority from both parties to the communication is architecturally distinct from every existing receipt or audit log system, in which receipt generation is performed by infrastructure controlled by or accessible to one or both parties. Furthermore, because receipts are signed using ML-DSA-65 (NIST FIPS 204, RFC 9881, OID 2.16.840.1.101.3.4.3.18), the receipt chain is resistant to retrospective forgery using future quantum computing capability, addressing the specific compliance risk that regulated industries face under long retention requirements (HIPAA: six years; SEC Rule 17a-4: six years; FINRA Rule 4511: six years) during which a nation-state adversary could harvest classically-signed audit logs today and forge records using post-quantum computational capability in the future.

The disclosed system is not a hierarchical governance framework for encrypted messaging and is not rendered obvious by Namavari et al. (Private Hierarchical Governance for Encrypted Messaging, IEEE S&P 2024, arXiv: 2406.19433). That work addresses post-delivery community governance applied after content has been decrypted within a recipient environment, using governance logic layered on top of the MLS protocol without modifying the key-release architecture. The present disclosure enforces admission control before any decryption occurs, with decryption key release conditioned on hardware-security-module-governed state machine advancement through artifact-stored precondition records. The governance authority model in that work is community-level moderation; the present disclosure is a communication object governance architecture enforcing pre-decryption, artifact-bound, state-machine-governed access control with HSM-boundary key revocation independent of endpoint behavior, which is architecturally distinct in every technically dispositive respect set forth in Background Section G.

The disclosed system is not a policy compliant secure messaging system and is not rendered obvious by Alwen et al. (Policy Compliant Secure Messaging, ASIACRYPT 2025, ePrint 2025/2179). That work is a content policy predicate system for detecting harmful content in E2EE messaging; it does not implement a formally defined communication state machine with artifact-stored state-transition precondition records, does not implement a hardware-security-module-bound key management service conditioning decryption key release on state machine advancement, does not provide post-release retroactive key revocation independent of endpoint behavior, and does not enforce cryptographic profile compliance as a state-machine-gated admission prerequisite. The subject of PCSM is content classification; the subject of the present disclosure is communication object governance. These are architecturally distinct systems governed by different mechanisms as set forth in Background Section H.

The partially-released state (state code 0x05) and per-attachment release control described in Section 4 (Table 5) and Section 6 (Table 6) of this specification constitute disclosed subject matter of the present disclosure and are not disclaimed hereby. Failure to recite partially-released state or per-attachment release conditions in the appended claims does not constitute a disclaimer of that subject matter for purposes of claim construction or prosecution history estoppel.

What is claimed is:

1. A communication control system comprising:
a hardware security module configured to store decryption keys associated with encrypted content of a communication object in a tamper-resistant hardware boundary and to release said decryption keys exclusively upon explicit authorization from a state transition controller, wherein no decryption key is accessible outside the tamper-resistant hardware boundary prior to such authorization, and wherein the hardware security module operates in conjunction with a hardware-security-module-bound key management service that manages decryption key storage and release operations within the tamper-resistant hardware boundary;
one or more processors communicatively coupled to the hardware security module; and
a memory storing executable instructions that, when executed by the one or more processors, configure the system to implement:
an ingress gateway configured to receive a communication object in a first communication plane and to separate the communication object into an outer delivery component retained in the first communication plane and an inner content component forwarded to a second communication plane, the inner content component comprising encrypted content and a message authority artifact that is cryptographically bound to the encrypted content such that modification of the message authority artifact invalidates integrity verification, and wherein the outer delivery component contains no decryption keys, no decryption material, and no plaintext content of the communication object;
an admission control engine configured to perform an admission evaluation of the inner content component in the second communication plane without decrypting the encrypted content, wherein the admission evaluation is performed after delivery of the outer delivery component in the first communication plane and before any decryption key is released, the admission evaluation comprising evaluating one or more authorization conditions encoded in the message authority artifact, including at least a sender organization authorization condition and a sender role authorization condition evaluated against a communication admission matrix;
a state transition controller comprising a state transition validation engine configured to maintain a formally defined communication state machine for the communication object and to execute deterministic validation logic against state-transition precondition records stored in association with the message authority artifact before authorizing any state transition, wherein: state machine advancement from an admission-pending state to an admitted state requires a successful admission evaluation result from the admission control engine; decryption keys are released by the hardware security module only upon state machine advancement to a released state; and
absence or integrity failure of the message authority artifact causes the state transition validation engine to return a rejection result independent of all other evaluation inputs; and
wherein the message authority artifact is required for state machine advancement from the admission-pending state such that no state machine advancement to a more permissive state occurs as a consequence of message delivery alone.

2. The system of claim 1, further comprising a cryptographic validation module configured to validate a cryptographic profile associated with the communication object against an approved cryptographic policy as a state-transition precondition for advancement from the admission-pending state to the admitted state, wherein failure of cryptographic profile validation prevents state machine advancement regardless of whether a sender signature associated with the communication object is algorithmically valid, such that cryptographic profile compliance is evaluated independently of and in addition to signature validity.

3. The system of claim 1, further comprising a verifiable receipt generator configured to produce, for each governed state transition and governance event including admission events, failed admission events, release events, partial-release events, post-release modification events, revocation events, failure events, and lineage violation events, a cryptographically signed tamper-evident verifiable receipt comprising event type, communication object identifier, message authority artifact identifier, state-transition preconditions validated and evaluation results therefor, cryptographic profile in effect, actor identity, and a digital signature over the receipt produced using a non-exportable signing key maintained within the hardware security module, wherein verifiable receipts are appended to a tamper-evident audit log whose integrity is verifiable through a cryptographic hash chain in which each receipt includes a chain-hash field computed over canonical bytes of the preceding receipt, providing non-repudiable evidence of the governance conditions under which access to the encrypted content was granted, modified, or revoked.

4. The system of claim 1, further comprising a lineage tracking module configured to enforce, via a lineage continuity record generated upon admission of the communication object, that one or more derived communication objects generated from the communication object inherit at least a subset of the authorization conditions encoded within the message authority artifact, and a verifiable receipt generator configured to produce tamper-evident receipts for governance events including lineage violation events, wherein: the lineage continuity record encodes an authorized participant set, permitted message class codes, a required cryptographic profile floor, a maximum-authority ceiling for AI-agent-generated or machine-generated derived communications, a lineage depth limit, and a lineage authority certificate; and the lineage tracking module denies state machine advancement to any derived communication object that violates an inherited constraint, quarantines the violating derived communication, and causes the verifiable receipt generator to produce a tamper-evident lineage violation receipt encoding an asserted authority scope, a ceiling value, an agent identifier, and one or more communication object identifiers.

5. The system of claim 1, further comprising a post-release enforcement module configured to perform post-release control operations in response to a qualifying post-release event comprising at least one of: a sender-compromise indicator, a recipient-compromise indicator, a threat-intelligence update, or a policy change; the post-release control operations comprising at least one of: signaling the state transition controller to roll back the communication state machine from the released state to a reevaluation-pending or revoked state; directing the hardware security module to invalidate decryption keys within the tamper-resistant hardware boundary without requiring endpoint cooperation, rendering the encrypted content inaccessible on all recipient endpoints within a revocation enforcement latency bound architecturally independent of recipient endpoint behavior; or downgrading access from full content access to partial or redacted access.

6. The system of claim 1, wherein the message authority artifact comprises:
an artifact identifier field storing a globally unique identifier generated by a FIPS-compliant deterministic random bit generator;
a communication object binding field storing a cryptographic hash of the encrypted content such that modification of the encrypted content invalidates the binding;
a sender authority identifier field encoding a sender organization distinguished name and a sender role identifier drawn from an approved role registry;
a message classification field encoding a message class code evaluated against a communication admission matrix;
an admission conditions field storing a sequence of admission condition records each comprising a condition type code, a condition value, a failure disposition indicator, and an optional disjunction group identifier;
a release conditions field storing one or more release condition records including, where applicable, a biometric step-up requirement indicator and a time-bound expiration value;
a cryptographic profile specification field encoding required algorithm identifiers for classical and post-quantum signing and key encapsulation, a hybrid mode requirement indicator, a hardware root attestation requirement indicator, a downgrade prevention floor algorithm identifier, and a key provenance requirement level;
a lineage control field encoding a lineage identifier, an authorized participant set, permitted message class codes, a maximum authority ceiling for AI-agent-generated derived communications, a cryptographic profile floor, a lineage depth limit, and a lineage authority certificate;
a revocation rules field encoding one or more revocation rules each specifying a qualifying post-release trigger event type and a corresponding post-release control action; and
an artifact signature field storing a cryptographic signature over all preceding fields computed within a hardware security module using a non-exportable artifact-sealing key.

7. The system of claim 1, wherein the message authority artifact is signed by a trusted authority cryptographically distinct from a sending entity, the trusted authority comprising at least one of an organizational certification authority, a government trust anchor, or a hardware-root-of-trust attestation authority, and wherein the admission control engine verifies the signature of the trusted authority as a condition of the admission evaluation.

8. The system of claim 2, wherein the message authority artifact is generated and sealed within a hardware security module, trusted platform module, or secure enclave using a non-exportable signing key maintained exclusively within the hardware boundary, such that the signing key cannot be exported or used outside the hardware boundary, and wherein the cryptographic validation module evaluates hardware-root attestation evidence embedded in or referenced by the message authority artifact as a state-transition precondition for advancement from the admission-pending state.

9. The system of claim 1, wherein the admission evaluation further comprises evaluating at least one of recipient device posture state, recipient identity assurance level, or recipient execution environment integrity as a condition of recipient eligibility determination, and wherein the state transition controller maintains the communication object in the admission-pending state when any recipient eligibility condition is not satisfied.

10. The system of claim 2, wherein the system supports a federated multi-domain configuration comprising a plurality of independent restricted recipient domains each maintaining a sovereign communication admission matrix, wherein: each domain independently maintains an admission control engine, a state transition controller, and a cryptographic validation module that independently evaluate admission conditions for communications received from other federation participants without delegating admission authority to any other domain; cross-domain communication governance is established through mutual trust descriptors exchanged between domain admission authorities, each trust descriptor encoding one or more authorized sender classes, permitted message classes, approved cryptographic profiles, and maximum-authority ceilings applicable to AI-agent-originated communications for a defined domain pair; and trust descriptors are distributable to participating domains through authenticated, integrity-protected trust-update packages verifiable using locally held root trust anchors, enabling federated admission governance in sovereign and air-gapped deployment topologies without requiring live cross-domain network queries during admission evaluation.

11. The system of claim 1, wherein the state-transition preconditions stored in association with the message authority artifact comprise, for each state transition, one or more of: a required admission evaluation result type, a required cryptographic profile compliance status, a required recipient eligibility status, a required secondary authorization event completion status, and a required release condition satisfaction status; wherein the state transition controller validates each applicable precondition against the current state of the communication object and the current evaluation results before executing any state transition; and wherein validation failure for any applicable precondition prevents execution of the corresponding state transition regardless of the outcome of other applicable preconditions.

12. The system of claim 1, wherein, upon receipt of a failed admission evaluation result from the admission control engine, the system enforces defined failure enforcement behavior comprising:
retaining the communication object in the admission-pending state without advancing the state machine to any more permissive state; preventing release of any decryption keys associated with the encrypted content by the hardware-security-module-bound key management service;
preventing exposure of the encrypted content to any recipient system, process, or user; and
generating a tamper-evident failure record comprising a communication object identifier, a message authority artifact identifier, a description of the nature of the admission failure, and a timestamp, wherein the failure record is appended to a tamper-evident audit log and wherein absence of a failure record in the audit log for a communication object remaining in the admission-pending state is detectable as evidence of a non-conformant implementation.

13. The system of claim 2, wherein the approved cryptographic policy requires at least one post-quantum cryptographic algorithm, and wherein the cryptographic validation module returns a failed admission evaluation result to the admission control engine when the cryptographic profile does not include a compliant post-quantum algorithm, regardless of algorithmic validity of the sender signature.

14. The system of claim 2, wherein the approved cryptographic policy requires a hybrid cryptographic configuration combining at least one classical cryptographic algorithm and at least one post-quantum cryptographic algorithm, such that compromise of either algorithm family independently does not compromise the communication object, and wherein the hybrid configuration is evaluated as a unified state-transition precondition.

15. The system of claim 2, wherein the cryptographic validation module enforces a downgrade-prevention requirement stored as a state-transition precondition in association with the message authority artifact, such that a communication object specifying a cryptographic profile that fails to satisfy a minimum-approved assurance level encoded in the state-transition precondition records is denied state machine advancement regardless of other precondition satisfaction.

16. The system of claim 1, wherein the released state is configurable as at least one of a time-bound release state, a condition-bound release state, or a context-dependent release state, wherein: a time-bound release state causes the state transition controller to transition the communication object from the released state to a reevaluation-pending state upon expiration of a time-bound precondition stored in association with the artifact; a condition-bound release state causes the state transition controller to monitor ongoing release conditions and initiate reevaluation-pending transition upon failure of any monitored condition; and a context-dependent release state permits decryption-key access only within a defined execution environment, enclave, or geographic context specified in a release precondition record.

17. The system of claim 1, wherein state machine advancement from the admitted state to the released state requires completion of a secondary authorization event stored as a release precondition in association with the message authority artifact, the secondary authorization event comprising at least one of a biometric verification producing a time-limited message-scoped biometric assurance token that includes a cryptographic scope binding field containing a hash of an artifact identifier associated with the message authority artifact to which the token applies, a hardware-attested step-up authentication event, or an out-of-band approval from a designated organizational authority.

18. A computer-implemented method of controlling decryption key release through hardware-security-module-governed, artifact-bound state-machine precondition evaluation, the method being executed by a communication control system comprising a hardware security module that stores decryption keys in a tamper-resistant hardware boundary and releases decryption keys exclusively upon authorization from a state transition controller, the communication control system further comprising a hardware-security-module-bound key management service that manages decryption key storage and release operations within the tamper-resistant hardware boundary, wherein the method produces a specific technical improvement over conventional communication access systems in that decryption key material is withheld from any recipient process and from any memory space accessible to any recipient process until hardware-enforced state machine advancement confirms satisfaction of artifact-stored precondition records, the method comprising:
receiving, by an ingress gateway executing on one or more processors of the communication control system, a communication object in a first communication plane, and separating, by the ingress gateway, the communication object into an outer delivery component retained in the first communication plane containing no decryption material and an inner content component comprising encrypted content and a message authority artifact that is cryptographically bound to the encrypted content and stores state-transition precondition records for a formally defined communication state machine, wherein the inner content component is forwarded to a second communication plane and the encrypted content is not presented to any memory space accessible to a recipient process prior to state machine advancement to the released state;
maintaining, by a state transition controller comprising a state transition validation engine executing on the one or more processors, the communication state machine for the communication object comprising at least delivered, admission-pending, admitted, release-qualified, released, partially-released, reevaluation-pending, revoked, and expired states, wherein each state transition requires the state transition validation engine to execute deterministic validation logic against the artifact-stored precondition records and authorize the transition before it is effectuated;
performing, by an admission control engine operating in the second communication plane and without decrypting the encrypted content, an admission evaluation comprising: evaluating authorization conditions encoded within the message authority artifact including a sender organization authorization condition and a sender role authorization condition evaluated against a communication admission matrix; validating a cryptographic profile against an approved cryptographic policy as a state-transition precondition, wherein validation failure prevents state machine advancement regardless of algorithmic signature validity; and determining recipient eligibility independent of successful delivery of the outer delivery component;
upon a failed admission evaluation, enforcing failure enforcement behavior comprising retaining the communication object in the admission-pending state, preventing decryption-key release on all participating nodes, preventing encrypted content exposure to any recipient system or process, and generating, by a verifiable receipt generator, a tamper-evident failure receipt replicated to all nodes of a tamper-evident audit log;
upon a successful admission evaluation, authorizing advancement of the communication object from the admission-pending state through the admitted, release-qualified, and released states by the state transition validation engine executing deterministic validation logic against the artifact-stored precondition records for each transition;
releasing, by executing a key-release operation within the tamper-resistant hardware boundary of the hardware security module, decryption keys associated with the encrypted content exclusively upon cross-node-consistent state machine advancement to the released state confirmed by a replicated state management store, wherein decryption key material does not exist outside the tamper-resistant hardware boundary of the hardware security module prior to the key-release operation;
generating, by the verifiable receipt generator using a non-exportable signing key maintained within the tamper-resistant hardware boundary of the hardware security module, a cryptographically signed tamper-evident verifiable receipt for each state transition and governance event, wherein the receipts are non-forgeable by any party without physical access to the hardware security module, and wherein receipts are appended to a hash-chained tamper-evident audit log replicated to all nodes; and
enforcing, by a lineage tracking component, lineage-bound constraints on derived communication objects generated from the communication object, wherein enforcing lineage-bound constraints comprises evaluating each derived communication object against a lineage continuity record generated upon admission of the root communication object, the lineage continuity record encoding a maximum-authority ceiling for AI-agent-originated and machine-generated derived communications, and denying state machine advancement and enforcing defined failure enforcement behavior for any derived communication object whose asserted authority scope exceeds the maximum-authority ceiling; and performing post-release control operations comprising at least one of rolling back the state machine across all distributed nodes, invalidating decryption keys by executing a key-invalidation operation within the tamper-resistant hardware boundary of the hardware security module within a revocation enforcement latency bound independent of recipient endpoint behavior, or downgrading rendering permissions, and generating a tamper-evident post-release receipt comprising revocation trigger, enforcement timestamp, and enforcement latency.

19. The method of claim 18, wherein the admission evaluation further comprises evaluating recipient device posture, identity assurance level, or execution environment integrity as state-transition preconditions, and wherein failure of any evaluated precondition causes the state transition controller to enforce defined failure enforcement behavior.

20. The method of claim 18, wherein validating the cryptographic profile comprises evaluating at least one post-quantum algorithm requirement or a hybrid classical-plus-post-quantum requirement as a state-transition precondition, and wherein the state transition controller is prevented from advancing the communication object from the admission-pending state when the cryptographic profile does not satisfy the approved policy regardless of algorithmic signature validity.

21. The method of claim 18, wherein enforcing lineage-bound constraints further comprises, for each derived communication object generated by an AI-agent or machine-originated process, generating a tamper-evident lineage violation receipt comprising the asserted authority scope, the maximum-authority ceiling value, a communication object identifier, and a message authority artifact identifier, and replicating the lineage violation receipt to all nodes of a tamper-evident audit log.

22. The method of claim 18, wherein performing post-release control operations comprises directing the hardware-security-module-bound key management service to invalidate decryption keys within a revocation enforcement latency bound architecturally independent of recipient endpoint behavior, rolling back the state machine to the revoked state across all distributed nodes simultaneously, and generating a tamper-evident revocation receipt comprising a revocation trigger, a timing value, an artifact identifier, and a hardware security module attestation quote confirming key invalidation.

23. A distributed communication control system comprising a plurality of computing nodes each operatively coupled to a replicated state management store, to a hardware security module maintaining a tamper-resistant hardware boundary for decryption key storage and invalidation, and to a hardware-security-module-bound key management service, the system enforcing a multi-phase communication control protocol comprising:
a verifiable receipt generator configured to produce cryptographically signed, tamper-evident receipts for all governed state transitions and governance events across all protocol phases, the receipts being replicated to all nodes of a tamper-evident audit log;
a delivery phase in which a communication object is transmitted in a first communication plane across the plurality of computing nodes, wherein the first communication plane carries only an outer delivery component containing no decryption keys, no decryption material, and no plaintext content, and wherein delivery of the outer delivery component to any node does not enable access to encrypted content of the communication object;
an admission phase enforced by a state transition controller operating across a plurality of distributed computing nodes through a replicated state management store, the admission phase comprising: retrieving, by a state transition validation engine, state-transition precondition records stored in association with a message authority artifact cryptographically bound to the communication object; executing deterministic validation logic against the retrieved precondition records; enforcing a cross-node synchronization constraint such that a state transition authorized on one distributed node is propagated to all other nodes in the replicated state management store before any node permits decryption-key release; and upon admission failure, enforcing distributed failure enforcement behavior comprising prevention of decryption-key release on all nodes, quarantine of the communication object across all nodes, and generation of a tamper-evident failure receipt replicated to all nodes;
a release phase in which decryption keys are released by a hardware-security-module-bound key management service exclusively upon cross-node-consistent state machine advancement to a released state, wherein advancement to the released state is confirmed by the replicated state management store across all participating nodes;
a post-release phase in which the state transition controller enforces state machine rollback across all distributed nodes simultaneously and the hardware-security-module-bound key management service enforces decryption-key invalidation with revocation enforcement latency bounded by replicated-state-management-store propagation time across all nodes, independent of recipient endpoint behavior; and
a lineage phase operating across the admission phase and release phase, in which the state transition controller evaluates derived communication objects against a lineage continuity record generated at root communication admission, enforcing inherited authorization constraints and maximum-authority ceilings for AI-agent-originated and machine-generated derived communications, and wherein a derived communication asserting authority exceeding the maximum-authority ceiling encoded in the lineage continuity record is denied state machine advancement, quarantined across all nodes, and causes the verifiable receipt generator to produce a tamper-evident lineage violation receipt replicated to all nodes of the tamper-evident audit log;
a verifiable receipt phase operating across all protocol phases and all distributed nodes, in which the verifiable receipt generator produces cryptographically signed, tamper-evident receipts replicated to all nodes of a tamper-evident audit log, providing non-repudiable audit evidence verifiable from any participating node;
and wherein the protocol enforces a cross-node consistency invariant such that no distributed node is capable of independently authorizing a state transition to a more permissive state without affirmative validation of artifact-stored precondition records and confirmation of consistency across the replicated state management store.

24. The system of claim 23, wherein the admission phase includes denying state machine advancement when a cryptographic profile of the communication object does not include a required post-quantum algorithm component, and wherein denial enforces defined failure behavior including generation of a tamper-evident failure receipt recording the profile validation failure.

25. The system of claim 23, wherein the post-release phase comprises directing the hardware-security-module-bound key management service to invalidate decryption keys in response to at least one of a sender-compromise indicator, a threat-intelligence update, or a policy change, and generating a tamper-evident revocation receipt comprising the invalidation trigger, enforcement timestamp, and communication object identifier.

26. The system of claim 23, wherein the lineage phase enforces a maximum-authority ceiling on AI-agent-generated or machine-generated derived communications through a cryptographic lineage continuity record, and wherein a derived communication asserting authority exceeding the maximum-authority ceiling is subjected to defined failure enforcement behavior including denial of state machine advancement and generation of a tamper-evident lineage violation receipt.

27. A non-transitory computer-readable medium storing executable instructions that, when executed by one or more processors, cause the one or more processors to implement a message authority artifact generation and enforcement system comprising:
separating, by an ingress gateway, a communication object received in a first communication plane into an outer delivery component retained in the first communication plane containing no decryption keys, no decryption material, and no plaintext content, and an inner content component forwarded to a second communication plane, the inner content component comprising encrypted content such that the encrypted content is not presented to any memory space accessible to a recipient process prior to state machine advancement to a released state;
generating and sealing a message authority artifact within a hardware security module, the message authority artifact being cryptographically bound to an encrypted content component of a communication object such that modification of the message authority artifact is detectable upon admission evaluation by an admission control engine, the message authority artifact encoding:
authorization conditions governing state machine advancement from an admission-pending state to an admitted state; state-transition precondition records for each state transition of a communication state machine governing the communication object; release conditions governing state machine advancement from the admitted state to a released state; a cryptographic profile specification encoding at least one of a post-quantum algorithm requirement, a hybrid classical-plus-post-quantum requirement, a hardware-root-of-trust key provenance attestation requirement, or a downgrade-prevention requirement; a lineage control parameter set encoding a lineage identifier, an authorized participant set, permitted message class codes, a maximum-authority ceiling applicable to AI-agent-generated derived communications, a cryptographic profile floor, a lineage depth limit, and a lineage authority certificate; revocation or downgrade rules specifying qualifying post-release events triggering post-release control operations; and a cryptographic signature over all preceding encoded data computed within the hardware security module using a non-exportable signing key;
performing, by an admission control engine operating in a second communication plane without decrypting the encrypted content, an admission evaluation of the message authority artifact comprising evaluating the authorization conditions and validating the cryptographic profile specification against an approved cryptographic policy as a state-machine-gated prerequisite independent of algorithmic signature validity;
enforcing, by a state transition controller, a formally defined communication state machine for the communication object by executing deterministic validation logic against the state-transition precondition records before authorizing any state transition, such that no state machine advancement to a more permissive state occurs without affirmative precondition record evaluation, and such that absence or integrity failure of the message authority artifact causes the state transition controller to return a rejection result independent of all other evaluation inputs;
causing a hardware security module to release decryption keys associated with the encrypted content exclusively upon state machine advancement to the released state following affirmative validation of all applicable state-transition precondition records, such that decryption key material does not exist outside the tamper-resistant hardware boundary of the hardware security module prior to such advancement; and
wherein the non-transitory computer-readable medium, when the executable instructions are executed by the one or more processors in conjunction with the hardware security module, causes enforcement of artifact-bound state-transition constraints and hardware-security-module-governed decryption key release as a coordinated protocol function producing a specific technical improvement over conventional communication access systems in that decryption key material is withheld from any recipient process and from any memory space accessible to any recipient process until hardware-enforced state machine advancement confirms satisfaction of artifact-stored precondition records.

28. The non-transitory computer-readable medium of claim 27, wherein the artifact is signed by a trusted authority cryptographically distinct from a sending entity and is generated and sealed within a hardware security module such that the signing key is non-exportable and hardware-root attestation evidence is embedded in or referenced by the artifact as a state-transition precondition for advancement from the admission-pending state.

29. The non-transitory computer-readable medium of claim 27, wherein the cryptographic profile specification encodes a hybrid classical-plus-post-quantum requirement such that both a classical algorithm requirement and a post-quantum algorithm requirement are required to be satisfied as a unified state-transition precondition, and wherein failure of either component of the hybrid requirement is recorded in a tamper-evident failure receipt by a verifiable receipt generator.

30. The non-transitory computer-readable medium of claim 27, wherein the lineage control parameter set encoded in the message authority artifact includes a maximum-authority ceiling for AI-agent-generated derived communications such that, when processed by an admission control engine, any derived communication asserting authority exceeding the ceiling is denied state machine advancement, the derived communication is retained without exposure of its encrypted content, no decryption keys are released, and a tamper-evident lineage violation receipt is generated comprising an asserted authority scope, a ceiling value, a communication object identifier, and an artifact identifier.
